(19) United States
(12) Patent Application Publication
(10) Pub. No.: US 2019/0390512 A1
(43) Pub. Date: Dec. 26, 2019

(54) DAYLIGHTING SYSTEM

(71) Applicant: PANASONIC INTELLECTUAL PROPERTY MANAGEMENT CO., LTD., Osaka (JP)

(72) Inventor: Yutaka IWAHORI, Osaka (JP)

(73) Assignee: PANASONIC INTELLECTUAL PROPERTY MANAGEMENT CO., LTD., Osaka (JP)

(21) Appl. No.: 16/465,275

(22) PCT Filed: Nov. 1, 2017
(86) PCT No.: PCT/JP2017/039501

§ 371 Date: May 30, 2019

(30) Foreign Application Priority Data
Dec. 1, 2016 (JP) 2016-234439
Feb. 24, 2017 (JP) 2017-033424

(51) Int. Cl. E06B 9/24; G02F 1/133; G01J 1/42; G02F 1/137; G02F 1/1343; G02F 1/167; G02F 1/1676; G02F 1/1685

(52) U.S. Cl. CPC E06B 9/24; G02F 1/13318; G01J 1/4204; G02F 1/137; E06B 3/6722; G02F 1/167; G02F 1/1676; G02F 1/1685; E06B 2009/2464; G02F 1/134309

(57) ABSTRACT

A daylighting system includes: a functional film which transmits light from an outdoor area of a building to introduce the light to an indoor area of the building; a weather detection unit configured to detect weather in a location at which the functional film is installed; and a control unit configured to control a transmittance of the functional film, based on a result of detection by the weather detection unit. The weather detection unit is configured to detect the weather, based on a result of comparing an illuminance of the light from the outdoor area with a reference value for the illuminance, and a result of comparing a color temperature of the light from the outdoor area with a reference value for the color temperature.

### TECHNICAL FIELD

The present invention relates to a daylighting system which introduces light from an outdoor area to an indoor area.

### BACKGROUND ART

Conventionally a device which can control the distribution of light which enters a room through a window has been known. Specifically, blinds, for instance, which control introducing light to an indoor area have been known. For example, Patent Literature (PTL) 1 discloses a technology of automatically adjusting the angle of slats of a blind according to the solar irradiance. PTL 2 discloses an electric blind.

### CITATION LIST

### Patent Literature

PTL 1: Japanese Unexamined Patent Application Publication No. H01-105896

PTL 2: Japanese Registered Utility No. 3164920

### SUMMARY OF THE INVENTION

### Technical Problem

However, the conventional blind disclosed by PTL 1 stated above has a problem that a malfunction occurs due to a temporary change in the solar irradiance caused by for instance, movement of a cloud, a person who passes by the blind, or a vehicle.

In view of this, the present invention is to provide a daylighting system which can inhibit the occurrence of malfunctions.

### Solution to Problem

In order to achieve the above object, a daylighting system according to an aspect of the present invention includes: a functional film which transmits light from an outdoor area to introduce the light to an indoor area; a weather detection unit configured to detect weather in a location at which the functional film is installed; and a control unit configured to control a transmittance of the functional film, based on a result of detection by the weather detection unit. The weather detection unit is configured to detect the weather, based on a result of comparing an illuminance of the light from the outdoor area with a reference value for the illuminance, and a result of comparing a color temperature of the light from the outdoor area with a reference value for the color temperature.

For example, a daylighting system according to an aspect of the present invention may include: a functional film which transmits light from an outdoor area to introduce the light to an indoor area; a weather detection unit configured to detect weather in a location at which the functional film is installed; and a control unit configured to control a transmittance of the functional film, based on a result of detection by the weather detection unit. The weather detection unit may be configured to detect the weather, based on a result of comparing a reference value with a ratio of direct light and diffuse light which are included in the light from the outdoor area.

### Advantageous Effects of Invention

According to the daylighting system according to the present invention, the occurrence of malfunctions can be inhibited.

### BRIEF DESCRIPTION OF DRAWINGS

FIG. 1 is a schematic diagram illustrating a configuration of a daylighting system according to Embodiment 1 and an example of application thereof.

FIG. 2 is a block diagram illustrating a functional configuration of the daylighting system according to Embodiment 1.

FIG. 3 illustrates cross-sectional views of a functional film included in the daylighting system according to Embodiment 1.

FIG. 4A is a cross-sectional view illustrating an example of a path of light when the functional film according to Embodiment 1 is operating in a light distribution mode.

FIG. 4B is a schematic diagram for describing the light distribution mode of the functional film according to Embodiment 1.

FIG. 5A is a cross-sectional view illustrating examples of paths of light when the functional film according to Embodiment 1 is operating in a transparent mode.

FIG. 5B is a schematic diagram for describing the transparent mode of the functional film according to Embodiment 1.

FIG. 6A illustrates changes in optical properties (light distribution angel and linear transmittance) with respect to a voltage applied to the functional film (daylighting film) according to Embodiment 1.

FIG. 6B illustrates a change in an optical property (haze) with respect to an applied voltage when a diffusion film is used as the functional film according to Embodiment 1.

FIG. 6C illustrates a change in an optical property (total light transmittance) with respect to an applied voltage when a light control film is used as the functional film according to Embodiment 1.

FIG. 7 is a flowchart illustrating operation of the daylighting system according to Embodiment 1.

FIG. 8.A illustrates results of weather detection by a weather detection unit included in a daylighting system according to a comparative example.

FIG. 8B illustrates results of weather detection by a weather detection unit included in the daylighting system according to Embodiment 1.

FIG. 9A is a schematic diagram illustrating direct light and diffuse light when the weather in a location at which a functional film according to Embodiment 2 is installed is sunny.

FIG. 9B is a schematic diagram illustrating direct light and diffuse light when the weather in a location at which the functional film according to Embodiment 2 is installed is cloudy.

FIG. 9C s a schematic diagram illustrating direct light and diffuse light when the weather in a location at which the functional film according to Embodiment 2 is in the shade of a building.

FIG. 10 is a block diagram illustrating a functional configuration of the daylighting system according to Embodiment 2.

FIG. 11 is a schematic diagram illustrating a configuration of the daylighting system according to Embodiment 2 and an example of application thereof.

FIG. 12 is a block diagram illustrating a functional configuration of a daylighting system according to Variation 1 of Embodiment 2.

FIG. 13 is a schematic diagram illustrating a configuration of the daylighting system according to Variation 1 of Embodiment 2 and an example of application thereof.

FIG. 14 is a block diagram illustrating a functional configuration of a daylighting system according to Variation 2 of Embodiment 2.

FIG. 15 is a schematic diagram illustrating a configuration of the daylighting system according to Variation 2 of Embodiment 2 and an example of application thereof.

FIG. 16 is a schematic diagram illustrating a different configuration of the daylighting system according to Variation 2 of Embodiment 2 and an example of application thereof.

FIG. 17 is a schematic diagram illustrating a relation between the orientation of an illuminance sensor according to Variation 2 of Embodiment 2 and the solar altitude.

FIG. 18 illustrates a configuration of a daylighting system according to Embodiment 3.

FIG. 19 is a diagram for describing the travel direction of light which has entered the functional film in a first mode.

FIG. 20 is a diagram for describing the travel direction of light which has entered the functional film in a second mode.

FIG. 21 is a first diagram illustrating an example of use of the daylighting system.

FIG. 22 is a second diagram illustrating an example of use of the daylighting system.

FIG. 23 schematically illustrates a capacitive touch-panel layer.

FIG. 24 schematically illustrates a resistive touch-panel layer.

FIG. 25 illustrates examples of detection target periods.

FIG. 26 illustrates a configuration of a daylighting system according to Variation 1 of Embodiment 3.

FIG. 27 illustrates a configuration of a daylighting system according to Variation 2 of Embodiment 3.

FIG. 28 is a schematic cross sectional view illustrating a structure of a light distribution layer according to Embodiment 4 in a no-voltage applying state.

FIG. 29 is a schematic cross sectional view illustrating a structure of the light distribution layer according to Embodiment 4 in a first-polarity voltage applying state.

FIG. 30 is a schematic cross sectional view illustrating a structure of the light distribution layer according to Embodiment 4 in a second-polarity voltage applying state.

### DESCRIPTION OF EXEMPLARY EMBODIMENTS

The following describes in detail a daylighting system according to an embodiment of the invention, with reference to the drawings. Note that the embodiments described below each illustrate a particular example of the present invention. Thus, the numerical values, shapes, materials, elements, the arrangement and connection of the elements, steps, and the processing order of the steps, for instance, indicated in the following embodiments are examples, and are not intended to limit the present invention. Therefore, among the elements in the following embodiments, elements not recited in any of the independent claims defining the most generic concept of the present invention are described as optional elements.

The drawings are schematic diagrams and do not necessarily give strict illustration. Accordingly for example, scales are not necessarily the same in the drawings. Note that throughout the drawings, the same numeral is given to substantially the same element, and redundant description is omitted or simplified.

### Embodiment 1

### [Configuration]

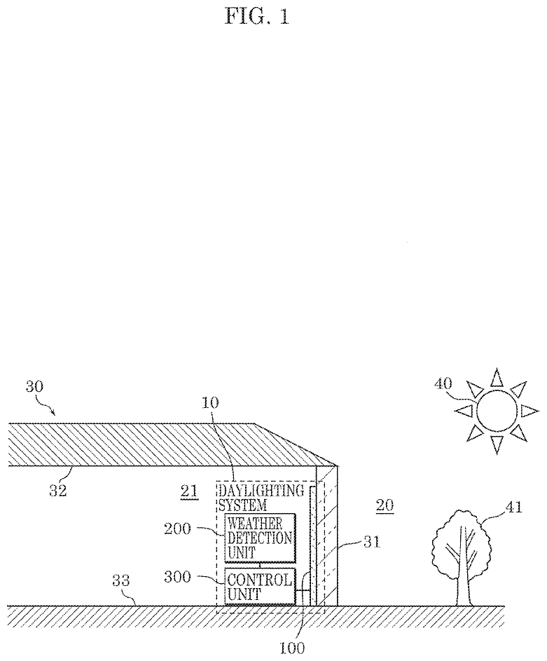

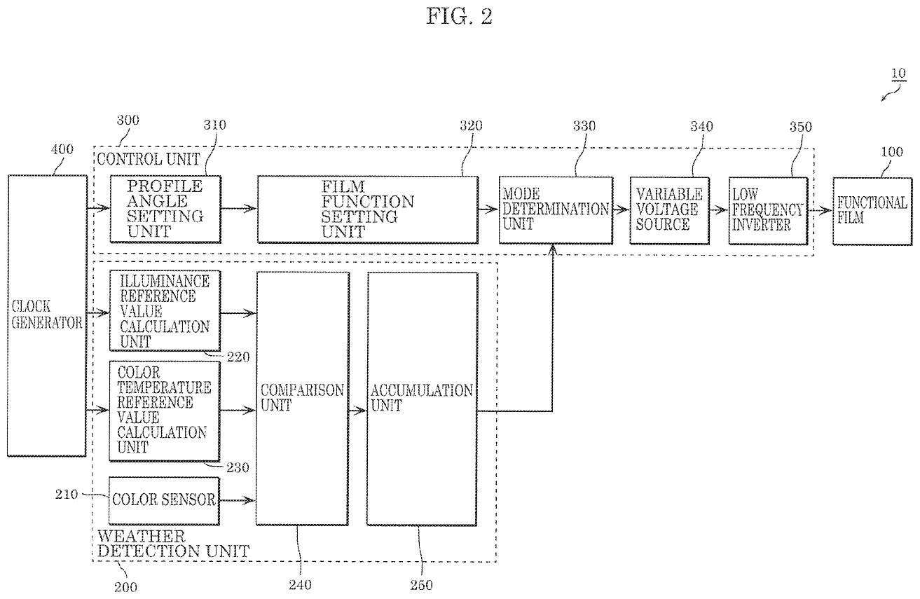

First, an outline of a daylighting system according to Embodiment 1 is to be described with reference to FIGS. 1 and 2. FIG. 1 is a schematic diagram illustrating a configuration of daylighting system 10 according to the present embodiment and an example of application thereof. FIG. 2 is a block diagram illustrating a functional configuration of daylighting system 10 according to the present embodiment.

As illustrated in FIG. 1, daylighting system 10 is a system which is applied to building 30, and introduces light from outdoor area 20 of building 30 to indoor area 21 of building 30. Daylighting system 10 adjusts the amount of light introduced to indoor area 21 according to the weather.

As illustrated in FIGS. 1 and 2, daylighting system 10 includes functional film 100, weather detection unit 200, and control unit 300. Functional film 100 is installed on window 31 of building 30, a sensor (color sensor 210 described below) of weather detection unit 200 is disposed near window 31, and control unit 300 is connected with functional film 100 and weather detection unit 200, whereby daylighting system 10 is applied to building 30.

Note that as illustrated in FIG. 2, daylighting system 10 further includes clock generator 400. Clock generator 400 generates a clock signal having a predetermined frequency, and outputs the clock signal to weather detection unit 200 and control unit 300. A clock signal is for synchronizing processes by weather detection unit 200 and control unit 300. Weather detection unit 200 and control unit 300 operate based on the clock signal output by clock generator 400.

The following describes in detail elements included in daylighting system 10.

### [Functional Film]

Functional film 100 is installed between outdoor area 20 and indoor area 21, and transmits light from outdoor area 20 to introduce the light to indoor area 21. In the present embodiment, functional film 100 is a light distribution film which has a light distribution mode and a transparent mode as operational modes.

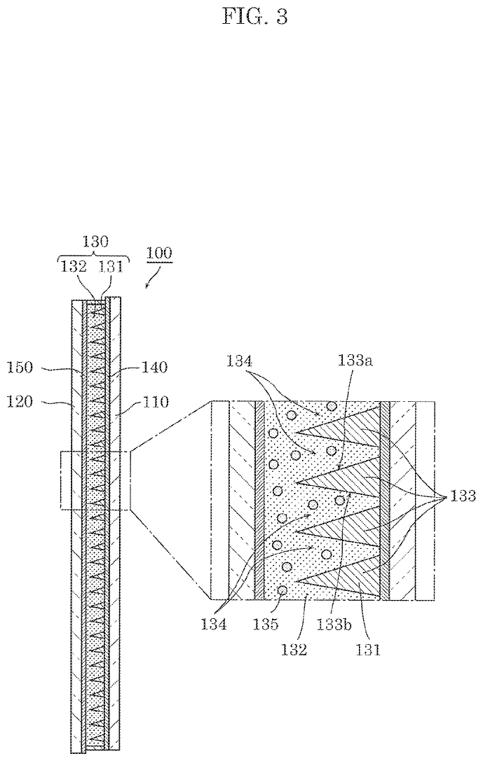

FIG. 3 is a cross-sectional view of functional film 100 included in daylighting system 10 according to the present embodiment. As illustrated in FIG. 3, functional film 100 includes first substrate 110, second substrate 120, light distribution layer 130, first electrode 140, and second electrode 150. Note that an adhesion layer for causing first electrode 140 and protruding and recessed structure 131 of light distribution layer 130 to adhere to each other may be provided on a surface of first electrode 140 on the light distribution layer 130 side. The adhesion layer is a light-transmitting adhesive sheet, for example.

Functional film 100 has a configuration in which first electrode 140, light distribution layer 130, and second electrode 150 are disposed in this order in the thickness direction between first substrate 110 and second substrate 120 that form a pair. Although not illustrated, spacers such as light-transmitting glass or resin particles (beads) may be disposed in order to secure the distance between first substrate 110 and second substrate 120.

In the present embodiment, functional film 100 is applied onto the surface of existing window 31 in indoor area 21 via an adhesive layer. Functional film 100 is disposed such that first substrate 110 is in outdoor area 20, second substrate 120 is in indoor area 21, lateral surface 133a of protrusion 133 is on the ceiling side, and lateral surface 133b is on the floor side. Stated differently, functional film 100 is disposed such that first substrate 110 is on the light entering side, and second substrate 120 is on the light exiting side.

### <First Substrate and Second Substrate>

First substrate 110 and second substrate 120 are light-transmitting substrates facing each other. Glass substrates or resin substrates can be used for first substrate 110 and second substrate 120, for example.

Examples of the material of the glass substrates include soda glass, alkali free glass, and high refractive index glass, for instance. Examples of the material of the resin substrates include polyethylene terephthalate (PET), polyethylene naphthalate (PEN), polycarbonate (PC), acrylic (PMMA), and epoxy, for instance. A glass substrate has an advantage that the light transmittance is high and moisture permeability is low. On the other hand, a resin substrate has an advantage that the substrate is less likely to scatter when damaged.

First substrate 110 and second substrate 120 may be made of the same material or different materials. Further, first substrate 110 and second substrate 120 are not limited to rigid substrates, and may be flexible substrates. In the present embodiment, first substrate 110 and second substrate 120 are transparent resin substrates made of PET resin.

Second substrate 120 is a counter substrate which faces first substrate 110, and is disposed in a position where second substrate 120 faces first substrate 110. First substrate 110 and second substrate 120 are spaced apart from each other by a predetermined distance of 10 μm to 30 μm, for example. First substrate 110 and second substrate 120 are bonded to each other with sealing resin such as an adhesive formed into a frame shape on outer-peripheral edges of the substrates.

Note that in a plan view, first substrate 110 and second substrate 120 each have, for example, a quadrilateral shape such as a square or rectangular shape. The shape, however, is not limited thereto, and may be round or a polygon other than a quadrilateral. An arbitrary shape may be employed.

### <Light Distribution Layer>

As illustrated in FIG. 3, light distribution layer 130 is disposed between first substrate 110 and second substrate 120. Light distribution layer 130 is a light-transmitting layer, and transmits incident light. Light distribution layer 130 distributes light which has entered. Specifically, light distribution layer 130 changes the travel direction of light when the light passes through light distribution layer 130.

Light distribution layer 130 has protruding and recessed structure 131 (protruding and recessed layer) and liquid crystal portion 132 (liquid crystal layer) which includes a liquid crystal material. Note that although not illustrated, alignment films which orient liquid crystal molecules 135 included in liquid crystal portion 132 may be provided with liquid crystal portion 132 therebetween.

Protruding and recessed structure 131 has a plurality of protrusions 133 and a plurality of recesses 134 as illustrated in FIG. 3. Specifically, protruding and recessed structure 131 includes protrusions 133 of a micro order size. Recesses 134 are between protrusions 133. Accordingly, one recess 134 is between two adjacent protrusions 133.

Protrusions 133 are repeated in a direction parallel to a principal surface of first substrate 110 (which is a surface on which first electrode 140 is provided). Specifically the direction in which protrusions 133 are disposed is a perpendicular (vertical) direction.

In the present embodiment, protrusions 133 are formed into stripes. Protrusions 133 are elongated protrusions which extend in a direction orthogonal to the direction in which protrusions 133 are disposed (more specifically, extend in a horizontal direction). Specifically protrusions 133 each have an elongated substantially triangular prism shape extending in a horizontal direction and having a triangular cross-sectional shape, and are disposed at equal intervals in a perpendicular direction. The cross-sectional shape of protrusions 133 is not limited to a triangle, and may be a trapezoid. Protrusions 133 have the same shape, but may have different shapes.

The height (the length in the thickness direction) of protrusions 133 is, for example, 2 μm to 100 μm, but is not limited to this height. The interval between adjacent protrusions 133, namely the width of recess 134 (in the perpendicular direction) is, for example, 0 μm to 100 μm. Thus, two adjacent protrusions 133 may be disposed with a predetermined interval therebetween and without being in contact with each other, or may be disposed in contact with each other. Note that the interval between adjacent protrusions 133 is not limited to 0 μm to 100 μm.

Protrusions 133 each have a pair of lateral surfaces 133a and 133b. As illustrated in FIG. 3, each pair of lateral surfaces 133a and 133b intersect in the perpendicular direction. In the present embodiment, protrusions 133 each have a cross-sectional shape tapered from first substrate 110 toward second substrate 120 (in the thickness direction). The pairs of lateral surfaces 133a and 133b are tilted at a predetermined angle relative to the thickness direction, and the distance (width of protrusion 133 (length in the perpendicular direction)) between each pair of lateral surfaces 133a and 133b gradually decreases from first substrate 110 toward second substrate 120.

For example, lateral surface 133a is a lateral surface (upper surface) on the vertically upper side, among a pair of lateral surfaces 133a and 133b. Lateral surface 133b is a lateral surface (lower surface) on the vertically lower side, among the pair of lateral surfaces 133a and 133b.

As the material of protrusions 133, for example, a light-transmitting resin material such as acrylic resin, epoxy resin, or silicone resin can be used. Protrusions 133 are formed using an ultraviolet curing resin material by molding or nanoimprinting, for example.

For example, protruding and recessed structure 131 can be formed, using an acrylic resin having a refractive index of 1.5, by being pressed against a mold so as to have a triangular cross section. The height of protrusion 133 is 10 μm, for example, and protrusions 133 are disposed at equal intervals of 2 μm in a perpendicular direction. The thickness of a root portion of protrusion 133 is 10 μm, for example. The value of the interval can range from 0 μm to 5 μm.

Liquid crystal portion 132 is disposed so as to fill recesses 134 of protruding and recessed structure 131. Liquid crystal portion 132 is disposed so as to fill the space between first electrode 140 and second electrode 150. For example, as illustrated in FIG. 3, protrusions 133 and second electrode 150 are spaced apart, and thus liquid crystal portion 132 is disposed so as to fill the space between second electrode 150 and protrusions 133.

In the present embodiment, liquid crystal portion 132 functions as a refractive-index control portion (or in other words, a refractive-index control layer) having a refractive index controllable for light in a visible light range by the application of an electric field. Specifically, liquid crystal portion 132 is constituted by a liquid crystal having liquid crystal molecules 135 responsive to an electric field, and thus the application of an electric field to light distribution layer 130 changes the orientations of liquid crystal molecules 135 so that the refractive index of liquid crystal portion 132 changes.

The application of a voltage between first electrode 140 and second electrode 150 applies an electric field to light distribution layer 130. Accordingly the electric field applied to light distribution layer 130 is changed by controlling a voltage applied to first electrode 140 and second electrode 150, so that the orientations of liquid crystal molecules 135 change and the refractive index of liquid crystal portion 132 changes. Specifically, the application of a voltage to first electrode 140 and second electrode 150 changes the refractive index of liquid crystal portion 132.

The birefringent material of liquid crystal portion 132 is a liquid crystal which includes liquid crystal molecules 135 that exhibit birefringence, for example. Examples of such a liquid crystal material include a sematic liquid crystal or a cholesteric liquid crystal in which liquid crystal molecules 135 are rod-shaped. Liquid crystal molecules 135 that exhibit birefringence have an ordinary index (no) of 1.5 and an extraordinary index (ne) of 1.7, for example.

Note that FIG. 3 illustrates a state in which no voltage is applied, and liquid crystal molecules 135 are oriented such that the long axis is parallel to the horizontal direction. When a voltage is applied between first electrode 140 and second electrode 150, liquid crystal molecules 135 are oriented such that the long axis is parallel to the thickness direction.

Note that an electric field may be applied to liquid crystal portion 132 using AC power or DC power. In the case of AC power, a voltage waveform may be a sine wave or a square wave.

Liquid crystal portion 132 is formed by injecting a positive type liquid crystal using a vacuum injection method, for example, in a state where outer-peripheral edges of first substrate 110 on and above which first electrode 140 and protruding and recessed structure 131 are formed, and outer-peripheral edges of second substrate 120 on which second electrode 150 is formed are sealed with sealing resin.

### <First Electrode and Second Electrode>

As illustrated in FIG. 3, first electrode 140 and second electrode 150 electrically form a pair, and are configured to apply an electric field to light distribution layer 130. Note that not only first electrode 140 and second electrode 150 electrically form a pair, but also the locations thereof form a pair. Thus, first electrode 140 and second electrode 150 are disposed so as to face each other. Specifically first electrode 140 and second electrode 150 are disposed with light distribution layer 130 therebetween.

First electrode 140 and second electrode 150 are light-transmitting electrodes, and transmit incident light. First electrode 140 and second electrode 150 are transparent conductive layers, for example. As the material of the transparent conductive layers, a transparent metal oxide such as indium tin oxide (ITO) or indium zinc oxide (IZO), a conductor containing resin made of a resin that contains an electric conductor such as silver nanowire or conductive particles, a thin metal film such as a silver film can be used. Note that first electrode 140 and second electrode 150 may each have a structure which includes a single layer made of such a material, or a structure in which layers made of such materials are stacked (for example, a structure in which a transparent metal oxide and a metal thin film are stacked). In the present embodiment, first electrode 140 and second electrode 150 are ITO films having a thickness of 100 nm.

First electrode 140 is disposed between first substrate 110 and protruding and recessed structure 131. Specifically first electrode 140 is formed on a surface of first substrate 110 on the light distribution layer 130 side.

On the other hand, second electrode 150 is disposed between liquid crystal portion 132 and second substrate 120. Specifically, second electrode 150 is formed on a surface of second substrate 120 on the light distribution layer 130 side.

Note that first electrode 140 and second electrode 150 are configured so as to be electrically connectable with, for example, an external power (low frequency inverter 350 as described below). For example, electrode pads for connecting with the external power may be drawn out from first electrode 140 and second electrode 150, and formed on first substrate 110 and second substrate 120.

First electrode 140 and second electrode 150 are formed by vacuum evaporation or sputtering, for example.

### <Operational Modes>

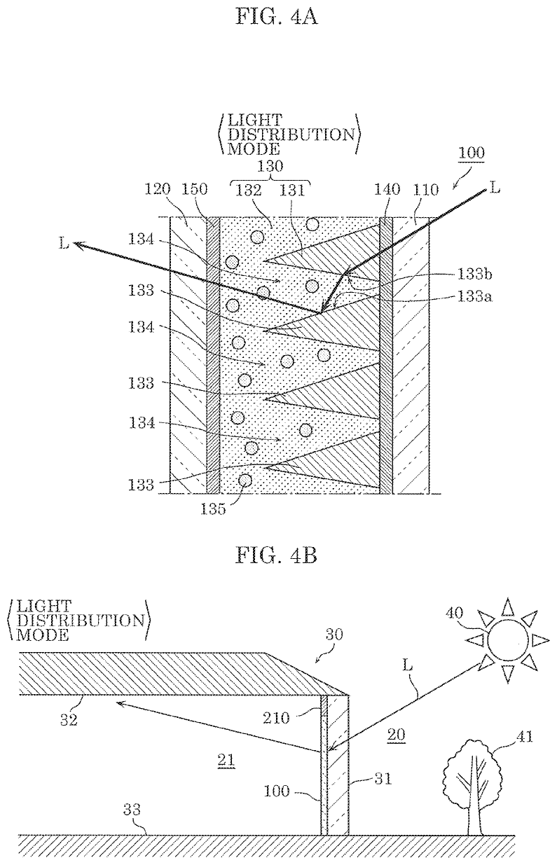

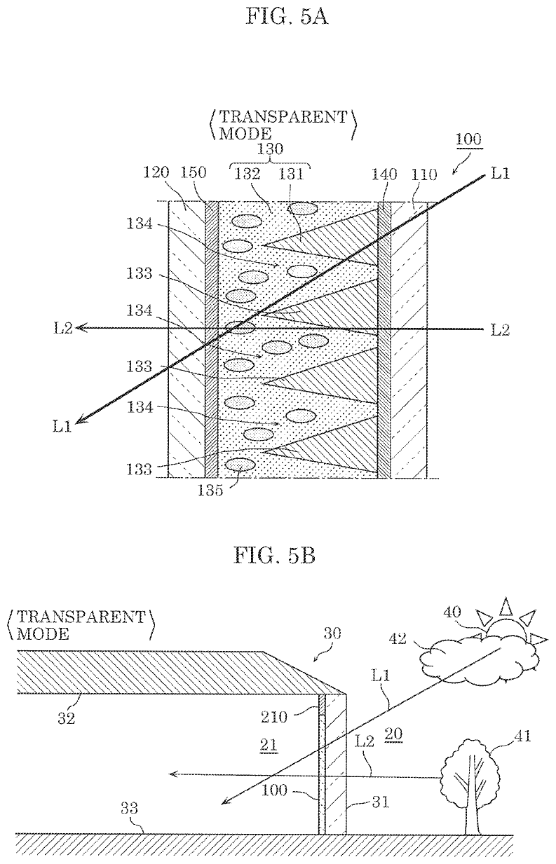

Here, the operational modes of functional film 100 are to be described with reference to FIGS. 4A to 5B.

In functional film 100, the orientations of liquid crystal molecules 135 included in liquid crystal portion 132 change according to an electric field applied to light distribution layer 130, or specifically the voltage applied between first electrode 140 and second electrode 150. Liquid crystal molecules 135 are rod-shaped liquid crystal molecules which exhibit birefringence, and thus each have different refractive indices according to the polarization condition of entering light.

Light such as sunlight which enters functional film 100 includes P polarized light (P polarized light component) and S polarized light (S polarized light component). The vibrating direction of P polarized light is substantially parallel to the short axes of liquid crystal molecules 135 in both the light distribution mode and the transparent mode. Accordingly the refractive index of liquid crystal molecules 135 for P polarized light does not depend on the operational modes, and thus maintains the ordinary index (no), or specifically 1.5. Accordingly the refractive index for P polarized light is substantially constant in light distribution layer 130, and thus P polarized light travels straight inside light distribution layer 130 as it is.

The refractive index of liquid crystal molecules 135 for S polarized light changes according to the operational modes. The following describes the details of the operational modes.

### <Light Distribution Mode>

FIG. 4A is a cross-sectional view illustrating an example of a path of light when functional film 100 according to the present embodiment is operating in the light distribution mode. FIG. 4B is a schematic diagram for describing the light distribution mode of functional film 100 according to the present embodiment.

Functional film 100 bends light which enters functional film 100 and causes the light to travel in a predetermined direction in the light distribution mode. The predetermined direction is a direction determined by a voltage applied between first electrode 140 and second electrode 150.

As illustrated in FIG. 4A, when functional film 100 operates in the light distribution mode, there is a difference in refractive index between protrusion 133 and liquid crystal portion 132 (recess 134). In the present embodiment, the refractive index of protrusion 133 is 1.5, and the refractive index of liquid crystal portion 132 is 1.7.

As illustrated in FIG. 4A, light L (S polarized light) such as sunlight which obliquely enters functional film 100 is refracted by lateral surface 133b of protrusion 133 when light L enters liquid crystal portion 132 after exiting protrusion 133, and thereafter is reflected (totally reflected) off lateral surface 133a of protrusion 133 when light L falls on protrusion 133 after passing through liquid crystal portion 132, so as to travel obliquely upwardly.

For example, as illustrated in FIG. 4B, functional film 100 causes light L from sun 40 which enters obliquely downwardly to travel obliquely upwardly. Accordingly ceiling 32 of building 30 is illuminated with light L. Illuminating ceiling 32 with light L can effectively brighten indoor area 21. For example, sufficient brightness can be secured without turning on a lighting device (not illustrated) disposed in indoor area 21, which achieves energy saving.

Note that as described above, P polarized light passes through functional film 100 as it is, also in the light distribution mode. Accordingly a user can see, for instance, tree 41 located in outdoor area 20 from indoor area 21, and functional film 100 can carry out the original function as a window.

As illustrated in FIG. 4B, in the present embodiment, the light distribution mode is adopted when sun 40 is not covered with a cloud, for instance, or stated differently, when the weather in a location at which functional film 100 is installed is sunny. Details will be described later.

### <Transparent Mode>

FIG. 5A is a cross-sectional view illustrating examples of paths of light when functional film 100 according to the present embodiment is operating in the transparent mode. FIG. 5B is a schematic diagram for describing the transparent mode of functional film 100 according to the present embodiment.

Functional film 100 allows light which has entered functional film 100 to travel straight in the transparent mode. Note that traveling straight means the angle of incidence of light which enters functional film 100 is substantially the same as the angle of emergence of the light. The angle of incidence and the angle of emergence do not need to be completely the same, and may differ by a few percent.

As illustrated in FIG. 5A, when functional film 100 is in the transparent mode, there is almost no difference in the refractive index of light distribution layer 130, and thus light L1 which obliquely enters functional film 100 passes through functional film 100 as it is and travels obliquely downwardly. Also, light L2 which enters functional film 100 perpendicularly thereto also passes through functional film 100 as it is and travels straight.

For example, as illustrated in FIG. 5B, functional film 100 allows light L1 which enters functional film 100 obliquely downwardly from sun 40 to travel obliquely downwardly as it is. Functional film 100 allows light L2 which enters perpendicularly, such as light reflected off tree 41, to travel straight as it is.

Accordingly in the transparent mode, the travel direction of light does not change, and thus the user can see tree 41, for instance, from indoor area 21. Specifically the user can see the scenery in outdoor area 20, and the original function of a window can be fully carried out.

In the transparent mode, there is almost no difference in the refractive index of light distribution layer 130, and thus light can be inhibited from being reflected or scattered, for instance, in light distribution layer 130. Accordingly in the transparent mode, the transmittance of functional film 100 is higher than that in the light distribution mode. Accordingly the amount of light introduced to indoor area 21 can be increased.

In the present embodiment, as illustrated in FIG. 5B, the transparent mode is adopted when sun 40 is covered with cloud 42, for instance, or stated differently, when the weather in a location at which functional film 100 is installed is cloudy. Details will be described later.

### <Applied Voltage>

The operational mode of functional film 100 changes according to a voltage (applied voltage) applied between first electrode 140 and second electrode 150. Specifically, in functional film 100, the light distribution angle in the light distribution mode (light exiting direction) and the light transmittance in the transparent mode change according to an applied voltage.

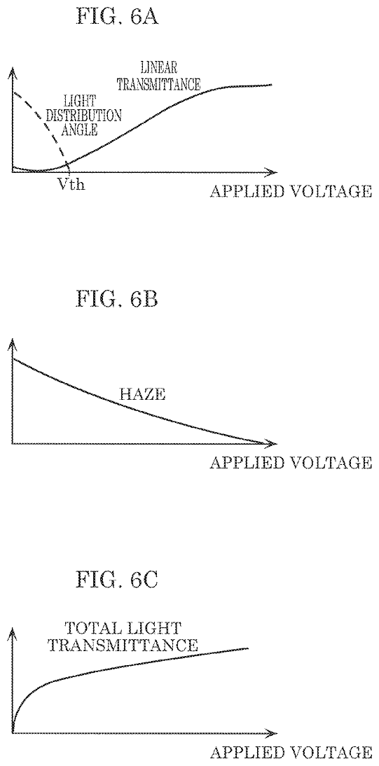

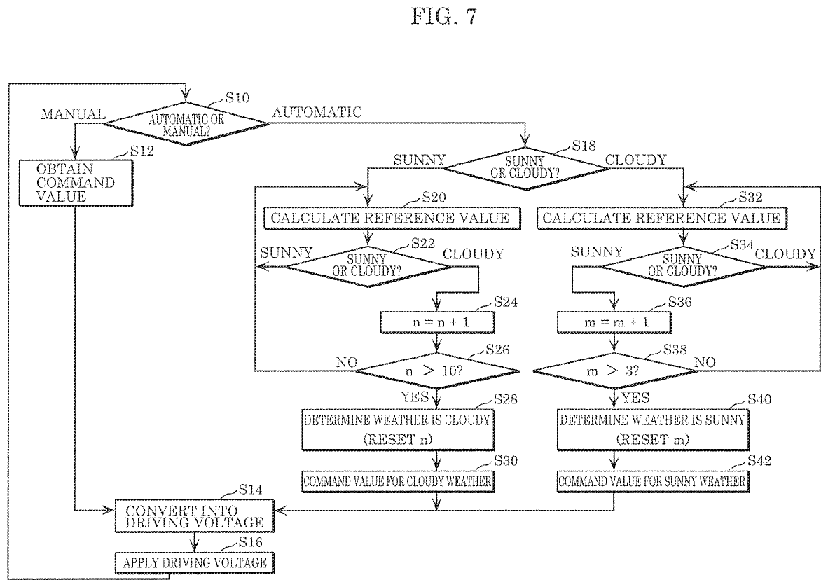

FIG. 6A illustrates changes in optical properties with respect to a voltage applied to functional film (daylighting film) 100 according to the present embodiment. FIG. 6A illustrates a change in the light distribution angle (indicated by the dashed line) and a change in the linear transmittance (indicated by the solid line). Note that a linear transmittance indicates a proportion of light which exits in the same travel direction as the travel direction of incident light with respect to the incident light.

As illustrated in FIG. 6A, functional film 100 operates in the light distribution mode when the applied voltage is lower than predetermined value Vth. Specifically, the light distribution angle of functional film 100 increases with a decrease in the applied voltage. Stated differently the lower the applied voltage is, the more functional film 100 bends incident light to cause the incident light to exit.

Thus, adjusting the applied voltage allows functional film 100 to change the travel direction (angle of emergence) of exiting light. For example, functional film 100 can change an area illuminated with light on ceiling 32 according to the applied voltage.

Functional film 100 operates in the transparent mode when the applied voltage is higher than predetermined value Vth. Specifically the linear transmittance of functional film 100 increases with an increase in the applied voltage. Thus, the higher the applied voltage is, the greater amount of incident light passes through functional film 100 as it is, which results in a high transmittance of functional film 100.

For example, when the weather is sunny, control unit 300 causes functional film 100 to operate in the light distribution mode by applying a voltage lower than predetermined value Vth. Accordingly, this causes light to travel toward ceiling 32. When the weather is cloudy, controller 300 causes functional film 100 to operate in the transparent mode by applying a voltage higher than predetermined value Vth. Accordingly the transmittance of functional film 100 increases, and thus more light can be introduced to indoor area 21.

Note that the present embodiment has described an example in which a light distribution film having the light distribution mode and the transparent mode as functional film 100, but functional film 100 is not limited thereto. For example, a diffusion film or a light control film may be used as functional film 100.

FIG. 6B illustrates a change in the optical property with respect to the applied voltage when a diffusion film is used as functional film 100 according to the present embodiment. FIG. 6B illustrates change in haze (turbidity).

The diffusion film is a functional film having haze (turbidity) that changes according to the applied voltage. The diffusion film diffuses (scatters) more incident light as haze is thicker, and carries out a function equivalent to the function of so-called frosted glass. The higher the applied voltage is, the thinner the haze of the diffusion film is, as Illustrated in FIG. 6B. Accordingly, transparency of the diffusion film increases with an increase in the applied voltage.

For example, when the weather is sunny, control unit 300 increases haze of the diffusion film by applying a lower voltage. Accordingly the transparency (transmittance) of the diffusion film decreases, and excessively strong light is inhibited from being introduced to indoor area 21. When the weather is cloudy control unit 300 decreases the haze of the diffusion film by applying a higher voltage. Accordingly, the transparency of the diffusion film increases, and more light can be introduced to indoor area 21.

FIG. 6C illustrates a change in the optical property with respect to the applied voltage when a light control film is used as functional film 100 according to the present embodiment. FIG. 6C illustrates a change in total light transmittance.

A light control film is a functional film having total light transmittance that changes according to an applied voltage. The higher the applied voltage is, the higher the total light transmittance of the light control film is, as illustrated in FIG. 6C. Accordingly the higher the applied voltage is, the higher the transparency of the light control film is.

For example, when the weather is sunny controller 300 decreases the total light transmittance of the light control film by applying a lower voltage. Accordingly the transparency (transmittance) of the light control film decreases, and excessively strong light is inhibited from being introduced to indoor area 21. When the weather is cloudy controller 300 decreases haze of the light control film by applying a higher voltage. Accordingly the transparency of the light control film increases, and more light can be introduced to indoor area 21.

Note that changes in optical properties illustrated in FIGS. 6A to 6C are mere examples, and the present embodiment is not limited thereto.

### [Weather Detection Unit]

Weather detection unit 200 detects the weather in a location at which functional film 100 is installed. In the present embodiment, weather detection unit 200 detects the weather based on a result of comparing an illuminance of light from outdoor area 20 with a reference value for the illuminance, and a result of comparing a color temperature of light from outdoor area 20 with a reference value for the color temperature.

Specifically weather detection unit 200 determines that the weather is cloudy when the illuminance of light from outdoor area 20 is lower than an illuminance reference value and furthermore the color temperature of the light from outdoor area 20 is higher than a color temperature reference value. Weather detection unit 200 determines that the weather is sunny when the illuminance of light from outdoor area 20 is higher than the illuminance reference value or when the color temperature of the light from outdoor area 20 is lower than the color temperature reference value.

Note that cloudy weather includes rainy weather. Further, cloudy weather also includes the case where the location at which functional film 100 is installed is in the shade, or in other words, the case where the location is where direct light (direct radiation) from sun 40 does not reach.

In the present embodiment, weather detection unit 200 further calculates the reference values, based on geographic information and date and time information of the location at which functional film 100 is installed. Specifically, weather detection unit 200 calculates both the illuminance reference value and the color temperature reference value, but may calculate only one of the values. Note that the illuminance reference value and the color temperature reference value may be predetermined fixed values.

Weather detection unit 200 repeats weather detection, and when weather detection unit 200 has consecutively obtained the results of the weather detection that indicate the identical weather over a predetermined period, weather detection unit 200 determines that the weather is the identical weather indicated by the results consecutively obtained by weather detection unit 200. Specifically weather detection unit 200 determines that the weather is cloudy when weather detection unit 200 has consecutively obtained the detection results indicating cloudy weather over a first period. Weather detection unit 200 determines that the weather is sunny when weather detection unit 200 has consecutively obtained the detection results indicating that the weather is sunny over a second period. At this time, the first period is longer than the second period. Details will be described later.

As illustrated in FIG. 2, weather detection unit 200 includes color sensor 210, illuminance reference value calculation unit 220, color temperature reference value calculation unit 230, comparison unit 240, and accumulation unit 250.

Color sensor 210 detects the illuminance and the color temperature (light color) of light from outdoor area 20. Color sensor 210 is disposed near functional film 100 in a position where light from outdoor area 20 is receivable. Color sensor 210 is disposed side by side with functional film 100, for example, as illustrated in FIGS. 4B and 5B. Note that color sensor 210 is disposed in indoor area 21, but may be disposed in outdoor area 20.

For example, color sensor 210 includes three photodiodes sensitive to red light (R), green light (G), and blue light (B). For example, color sensor 210 calculates an illuminance based on a light signal (G signal) received by the photodiode for green light. Specifically, color sensor 210 can assume the intensity of a G signal as an illuminance of light from outdoor area 20.

Color sensor 210 calculates the color temperature based on a ratio of a light signal (R signal) received by the photodiode for red light and a light signal (B signal) received by the photodiode for blue light. Alternatively color sensor 210 may calculate the color temperature based on CIE chromaticity coordinates.

Illuminance reference value calculation unit 220 calculates the illuminance reference value, based on geographic information and date and time information. Geographic information indicates the latitude of the location at which functional film 100 is installed, for example. Date and time information indicates the date and time for illuminance comparison, for example.

The illuminance reference value is an example of a first reference value and is a threshold regarding the illuminance, which is used for determining whether the weather is sunny or cloudy. For example, the illuminance reference value is a mean value (or an average) of the average of illuminance when the weather is sunny and the average of illuminance when the weather is cloudy.

The illuminance is the lowest (minimum) at times when sun 40 rises and sets, and reaches the highest (maximum) at the culmination time. In addition, the solar altitude changes seasonally, and thus the illuminance changes seasonally. Specifically, the illuminance is high in summer and low in winter. Furthermore, the higher the latitude of the location at which functional film 100 is installed, the lower the solar altitude is, and thus the illuminance is lower. Thus, the illuminance changes according to a location and the date and time, and thus illuminance reference value calculation unit 220 adjusts the illuminance reference value to an appropriate value according to the location and the date and time. Specifically illuminance reference value calculation unit 220 calculates, as the illuminance reference value, a mean value of the average of illuminance when the weather is sunny and the average of illuminance when the weather is cloudy at times for illuminance comparison in the location at which functional film 100 is installed.

Color temperature reference value calculation unit 230 calculates a color temperature reference value based on geographic information and date and time information. The color temperature reference value is an example of a second reference value, and is a threshold regarding the color temperature, which is used for determining whether the weather is sunny or cloudy. For example, the color temperature reference value is a mean value (or an average) of the average of color temperatures when the weather is sunny and the average of color temperatures when the weather is cloudy.

The color temperature is the lowest (minimum) when sun 40 rises and sets, and is the highest (maximum) at the culmination time. Furthermore, the solar altitude changes depending on a season, and thus the color temperature changes depending on the season. Specifically, the color temperature is high in summer and low in winter. Further, the higher the latitude of the location at which functional film 100 is disposed is, the lower the solar altitude is, and thus the color temperature is low. Accordingly, the color temperature changes according to a location and date and time, and thus color temperature reference value calculation unit 230 adjusts the color temperature reference value to an appropriate value according to the location and date and time. Specifically, color temperature reference value calculation unit 230 calculates, as the color temperature reference value, a mean value of the average of color temperatures when the weather is sunny and the average of color temperatures when the weather is cloudy at times for color temperature comparison in the location at which functional film 100 is installed.

Comparison unit 240 compares the illuminance detected by color sensor 210 with the illuminance reference value calculated by illuminance reference value calculation unit 220. Comparison unit 240 further compares the color temperature detected by color sensor 210 with the color temperature reference value calculated by color temperature reference value calculation unit 230.

Comparison unit 240 outputs a signal which indicates cloudy weather (cloudy weather signal) to accumulation unit 250 when the detected illuminance is lower than the illuminance reference value, and furthermore, the detected color temperature is higher than the color temperature reference value. Comparison unit 240 outputs a signal which indicates sunny weather (sunny weather signal) to accumulation unit 250 when the detected illuminance is higher than the illuminance reference value or when the detected color temperature is lower than the color temperature reference value. A cloudy weather signal and a sunny weather signal each correspond to the result of one weather detection.

Accumulation unit 250 separately accumulates the received cloudy weather signal and the received sunny weather signal. Specifically, accumulation unit 250 counts the number (accumulation count) of consecutively received cloudy weather signals and the number of consecutively received sunny weather signals. Accumulation unit 250 outputs a cloudy weather signal to mode determination unit 330 of control unit 300 when accumulation count n of cloudy weather signals exceeds a predetermined first threshold (for example, 10). Accumulation unit 250 outputs a sunny weather signal to mode determination unit 330 of control unit 300 when accumulation count m of sunny weather signals exceeds a predetermined second threshold (for example, 3). In the present embodiment, the first threshold is greater than the second threshold.

Note that comparison unit 240 operates based on, for example, a clock signal, and can perform comparison processing for each certain period. Accordingly accumulation counts in and n indicating accumulated comparison results correspond to the duration in which the weather is consecutively determined to be sunny and the duration in which the weather is consecutively determined to be cloudy respectively. Specifically the first threshold and the second threshold are a threshold of the duration in which the weather is cloudy and a threshold of the duration in which the weather is sunny, respectively, and correspond to the first period and the second period, respectively.

Illuminance reference value calculation unit 220, color temperature reference value calculation unit 230, comparison unit 240, and accumulation unit 250 are implemented by a microcomputer (microcontroller), for example. Specifically the microcomputer includes nonvolatile memory in which a program is stored, volatile memory which is a temporary storage area for executing the program, an input/output port, and a processor which executes the program, for instance. Note that illuminance reference value calculation unit 220, color temperature reference value calculation unit 230, comparison unit 240, and accumulation unit 250 may be constituted by software or hardware.

### [Control Unit]

Control unit 300 controls the transmittance of functional film 100, based on the result of detection by weather detection unit 200. For example, control unit 300 increases the transmittance of functional film 100 when weather detection unit 200 determines that the weather is cloudy. Control unit 300 decreases the transmittance of functional film 100 when weather detection unit 200 determines that the weather is sunny.

In the present embodiment, control unit 300 controls the operational mode of functional film 100, based on a result of weather detection. Specifically control unit 300 controls a voltage applied to first electrode 140 and second electrode 150 based on the detection result, thus controlling the operational mode of functional film 100. Control unit 300 causes functional film 100 to operate in the light distribution mode when the weather detected by weather detection unit 200 is sunny. Control unit 300 causes functional film 100 to operate in the transparent mode when the weather detected by weather detection unit 200 is cloudy.

As illustrated in FIG. 2, control unit 300 includes profile angle setting unit 310, film function setting unit 320, mode determination unit 330, variable voltage source 340, and low frequency inverter 350.

Profile angle setting unit 310 sets a profile angle. A profile angle is an angle of projection formed on floor 33 when sunlight comes in through window 31 (functional film 100). Specifically the profile angle is formed between a normal to window 31 and a straight line which connects the tip of the projection and the upper edge of window 31. For example, when h [deg] denotes the solar altitude and γ [deg] denotes the azimuth relative to a normal to the surface of the window, profile angle α is represented by tan⁻¹ (tan h/cos γ).

The profile angle changes according to the location and the date and time. Profile angle setting unit 310 sets a profile angle suitable for the location at which functional film 100 is installed and date and time when functional film 100 is to be controlled, based on, for example, geographic information and date and time information.

Film function setting unit 320 sets film functions of functional film 100. The film functions are functions according to optical properties of functional film 100. Specifically, the film functions indicate changes in the optical properties with respect to an applied voltage as illustrated in FIGS. 6A to 6C. In the present embodiment, film function setting unit 320 sets, as film functions, the functions which indicate a change in transmittance and a change in the light distribution angle with respect to an applied voltage illustrated in FIG. 6A.

Mode determination unit 330 determines the operational mode of functional film 100, based on a signal output from accumulation unit 250 of weather detection unit 200. Specifically mode determination unit 330 determines a voltage (driving voltage) for driving functional film 100, namely, a voltage applied to first electrode 140 and second electrode 150. Mode determination unit 330 causes variable voltage source 340 to operate at the determined driving voltage.

For example, when mode determination unit 330 receives a cloudy weather signal input from accumulation unit 250, mode determination unit 330 determines a voltage higher than predetermined value Vth as a driving voltage so as to cause functional film 100 to operate in the transparent mode. When mode determination unit 330 receives a sunny weather signal input from accumulation unit 250, mode determination unit 330 determines a voltage lower than predetermined value Vth as a driving voltage so as to cause functional film 100 to operate in the light distribution mode.

Note that mode determination unit 330 may receive an external input. Specifically mode determination unit 330 may receive an instruction (mode instruction) indicating user selection of the operational mode of functional film 100. Upon receipt of the mode instruction from a user, mode determination unit 330 causes variable voltage source 340 to operate based on the received mode instruction.

Variable voltage source 340 is a DC voltage supply which can change an output voltage value. Variable voltage source 340 outputs a voltage having a voltage value determined by mode determination unit 330.

Low frequency inverter 350 converts the DC voltage output from variable voltage source 340 into an AC voltage, and outputs the AC voltage. The output terminals of low frequency inverter 350 are connected with first electrode 140 and second electrode 150 of functional film 100. Accordingly a predetermined AC voltage is applied to functional film 100.

Profile angle setting unit 310, film function setting unit 320, and mode determination unit 330 are implemented by a microcomputer (microcontroller), for example. Specifically, the microcomputer includes nonvolatile memory in which a program is stored, volatile memory which is a temporary storage area for executing the program, an input/output port, and a processor which executes the program, for instance. Note that profile angle setting unit 310, film function setting unit 320, and mode determination unit 330 may be constituted by software or by hardware.

### [Operation]

Next, operation of daylighting system 10 according to the present embodiment is to be described with reference to FIG. 7. FIG. 7 is a flowchart illustrating operation of daylighting system 10 according to the present embodiment.

As illustrated in FIG. 7, mode determination unit 330 determines a control mode of functional film 100 (S10). The control mode includes a manual mode based on a user instruction and an automatic mode based on a result of weather detection. Note that the manual mode and the automatic mode are switchable according to whether an instruction is received from a user. For example, mode determination unit 330 switches the control mode to the manual mode when an instruction regarding the control of functional film 100 is received from a user, and switches the control mode to the automatic mode when such an instruction is not received.

When the control mode is the manual mode (“manual” in S10), mode determination unit 330 obtains a command value received from the user (S12). The command value is an instruction indicating the operational mode of functional film 100. Specifically, the command value indicates the light distribution mode or the transparent mode. Alternatively the command value may be a value that indicates the transmittance of functional film 100.

Mode determination unit 330 converts the obtained command value into a driving voltage (S14). Next, mode determination unit 330 applies the converted driving voltage by controlling variable voltage source 340 (S16). After that, the processing returns to step S10 and processing of steps S10 to S16 is repeated.

When the control mode is the automatic mode (“automatic” in S10), the processing branches according to whether the current weather is sunny or cloudy (S18).

When the current weather is sunny (“sunny” in S18), illuminance reference value calculation unit 220 and color temperature reference value calculation unit 230 calculate the illuminance reference value and the color temperature reference value, respectively (S20).

Next, comparison unit 240 determines whether the weather is sunny or cloudy by comparing the calculated illuminance reference value and the calculated color temperature reference value with the illuminance and the color temperature detected by color sensor 210, respectively (S22). When the weather is sunny (“sunny” in S22), the processing returns to step S20, and processing of steps S20 and S22 is repeated at timing based on a clock signal.

When the weather is cloudy (“cloudy” in S22), accumulation unit 250 adds 1 to the value of accumulation count n since accumulation unit 250 receives a cloudy weather signal input from comparison unit 240 (S24). When accumulation count n is less than or equal to 10 (No in S26), the processing returns to step S20, and processing of steps S20 to S26 is repeated.

When accumulation count n exceeds 10 (Yes in S26), accumulation unit 250 determines that the weather is cloudy, and outputs a cloudy weather signal to mode determination unit 330 (S28). At this time, accumulation unit 250 resets accumulation count n (restores the count to 0).

Mode determination unit 330 receives the input cloudy weather signal, and thus sets a command value which indicates cloudy weather (S30). Mode determination unit 330 converts the obtained command value into a driving voltage (S14). Next, mode determination unit 330 applies the converted driving voltage by controlling variable voltage source 340 (S16). Then, the processing returns to step S10, and processing of steps S10 to S16 is repeated.

When the current weather is cloudy (“cloudy” in S18), illuminance reference value calculation unit 220 and color temperature reference value calculation unit 230 calculate the illuminance reference value and the color temperature reference value, respectively (S32).

Next, comparison unit 240 determines whether the weather is sunny or cloudy by comparing the calculated illuminance reference value and the calculated color temperature reference value with the illuminance and the color temperature detected by color sensor 210 (S34). When the weather is cloudy (“cloudy” in S34), the processing returns to step S32, and processing of steps S32 to S34 is repeated at timing based on a clock signal.

When the weather is sunny (“sunny” in S34), accumulation unit 250 receives a sunny weather signal input from comparison unit 240, and thus adds 1 to the value of accumulation count m (S36). When accumulation count in is less than or equal to 3 (No in S38), the processing returns to step S32, and processing of steps S32 to S38 is repeated.

When accumulation count m exceeds 3 (Yes in S38), accumulation unit 250 determines that the weather is sunny, and outputs the sunny weather signal to mode determination unit 330 (S40). At this time, accumulation unit 250 resets accumulation count in (restores the count to 0).

Mode determination unit 330 receives the input sunny weather signal, and thus sets a command value which indicates sunny weather (S42). Mode determination unit 330 converts the obtained command value into a driving voltage (S14). Next, mode determination unit 330 applies the converted driving voltage by controlling variable voltage source 340 (S16). After that, the processing returns to step S10, and processing of steps S10 to S16 is repeated.

Note that color sensor 210 calculates the illuminance and the color temperature regularly, and outputs the illuminance and the color temperature to comparison unit 240. Alternatively, color sensor 210 may synchronize with a clock signal. For example, color sensor 210 may calculate an illuminance and a color temperature and output the illuminance and the color temperature to comparison unit 240 at timing when illuminance reference value calculation unit 220 and color temperature reference value calculation unit 230 calculate the illuminance reference value and the color temperature reference value, respectively (S20 and S32).

### [Advantageous Effects and Others]

The following describes operational effects of daylighting system 10 according to the present embodiment, based on a comparison with a comparative example.

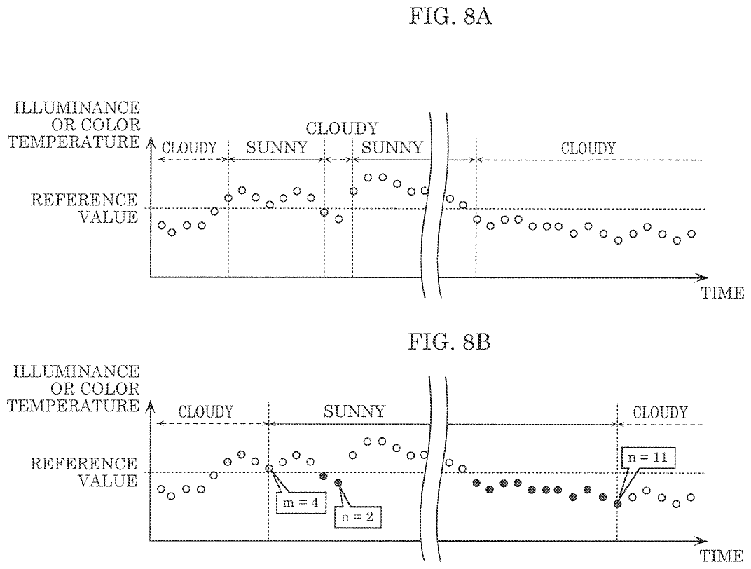

FIG. 8A illustrates results of weather detection by a weather detection unit included in a daylighting system according to the comparative example. The weather detection unit according to the comparative example controls the operational mode of functional film 100 without accumulating the results of illuminance comparison and color temperature comparison. Specifically, the weather detection unit according to the comparative example does not include accumulation unit 250.

In this case, as illustrated in FIG. 8A, the weather detection unit determines that the weather is sunny each time the illuminance or the color temperature exceeds the reference value, and determines that the weather is cloudy each time the illuminance or the color temperature is lower than the reference value. Accordingly, when color sensor 210 is shielded so that light does not enter, the weather detection unit determines that the weather is cloudy although the weather is sunny, and functional film 100 is caused to operate in the transparent mode. In particular, in the case where although light toward color sensor 210 is blocked, but light which enters most of the portions of functional film 100 is not blocked, strong light when the weather is sunny is introduced to indoor area 21, and thus a person in indoor area 21 feels glare.

In contrast, daylighting system 10 according to the present embodiment changes a voltage (driving voltage) to be applied to functional film 100 when sunny weather or cloudy weather is detected consecutively as also illustrated in FIG. 7. Thus, the operational mode of functional film 100 does not change due to the detection of sunny weather or cloudy weather only once.

FIG. 8B illustrates results of weather detection by weather detection unit 200 included in daylighting system 10 according to the present embodiment.

As illustrated in FIG. 8B, when the current weather is cloudy, if the number of times (namely, accumulation count mu) the weather is determined to be sunny exceeds 3 times, or stated differently, the weather is determined to be sunny for the fourth time, accumulation unit 250 outputs a sunny weather signal. Accordingly, the weather is determined to be sunny, and functional film 100 operates in the transparent mode.

Similarly, when the current weather is sunny if the number of times (namely, accumulation count n) the weather is determined to be cloudy exceeds 10 times, or stated differently, when the weather is determined to be cloudy for the eleventh time, accumulation unit 250 outputs a cloudy weather signal. Accordingly, the weather is determined to be cloudy, and functional film 100 operates in the light distribution mode.

Note that in the present embodiment, a first threshold for determining that the weather is cloudy is 10, and a second threshold for determining that the weather is sunny is 3, and thus the first threshold is greater than the second threshold. Thus, settings are configured such that a period (a second period) taken to determine that the weather is sunny is shorter, and on the contrary, a period (a first period) taken to determine that the weather is cloudy is longer. Accordingly even when the illuminance and the color temperature temporarily drop below the reference values, the weather is not determined to be cloudy.

This inhibits sunny weather from being incorrectly determined to be cloudy and inhibits functional film 100 from incorrectly operating in the transparent mode in which the transmittance is high. Accordingly this inhibits giving glare to a person in indoor area 21.

As described above, daylighting system 10 according to the present embodiment is installed between outdoor area 20 and indoor area 21, and includes: functional film 100 which transmits light L from outdoor area 20 to introduce light L to indoor area 21; weather detection unit 200 configured to detect weather in a location at which functional film 100 is installed; and control unit 300 configured to control a transmittance of functional film 100, based on a result of detection by weather detection unit 200. Weather detection unit 200 is configured to detect the weather, based on a result of comparing an illuminance of light L from outdoor area 20 with a reference value for the illuminance, and a result of comparing a color temperature of light L from outdoor area 20 with a reference value for the color temperature.

Accordingly the weather is determined using not only an illuminance but also a color temperature, and thus incorrect weather determination can be inhibited, and malfunction of functional film 100 can be inhibited.

For example, weather detection unit 200 is configured to determine that the weather is cloudy when the illuminance is lower than a first reference value and the color temperature is higher than a second reference value, and control unit 300 is configured to increase the transmittance of functional film 100 when weather detection unit 200 determines that the weather is cloudy.

Accordingly, when the weather is cloudy, light can be efficiently introduced to indoor area 21.

For example, functional film 100 has a light distribution mode in which light which has entered is bent and caused to travel in a predetermined direction, and a transparent mode in which a transmittance is higher than a transmittance in the light distribution mode, and the light which has entered is caused to travel straight, and control unit 300 is configured to: cause functional film 100 to operate in the light distribution mode when the weather detected by weather detection unit 200 is sunny; and cause functional film 100 to operate in the transparent mode when the weather detected by weather detection unit 200 is cloudy.

Accordingly, when the weather is sunny functional film 100 can cause the introduced light to travel in a predetermined direction (for example, toward ceiling 32), and thus indoor area 21 can be effectively brightened. In addition, when the weather is cloudy, functional film 100 operates in the transparent mode in which the transmittance is high, and thus light can be efficiently introduced to indoor area 21.

For example, functional film 100 includes: first substrate 110 and second substrate 120 which are light-transmitting substrates facing each other; light distribution layer 130 which is disposed between first substrate 110 and second substrate 120, and distributes the light which has entered; and first electrode 140 and second electrode 150 which are disposed with light distribution layer 130 therebetween, light distribution layer 130 includes: protruding and recessed structure 131 which includes a plurality of protrusions 133; and liquid crystal portion 132 which includes liquid crystal molecules 135 and is in a space defined by the plurality of protrusions 133, and control unit 300 is configured to control an operational mode of functional film 100 by controlling, based on a result of detection by weather detection unit 200, a voltage applied between first electrode 140 and second electrode 150.

Accordingly, not only the operational modes can be switched according to an applied voltage, but also the light distribution angle and the transmittance can be readily controlled.

For example, weather detection unit 200 is configured to repeat weather detection, and when weather detection unit 200 has consecutively obtained results of the weather detection that indicate identical weather over a predetermined period, weather detection unit 200 is configured to determine that the weather is the identical weather indicated by the results consecutively obtained by weather detection unit 200.

Accordingly, a temporary change in the illuminance and the color temperature does not result in a determination that the weather has changed, and thus the operational mode of functional film 100 does not change. When color sensor 210 is temporarily shielded, for instance, sunny weather can be inhibited from being accidentally determined to be cloudy and thus malfunction of functional film 100 can be inhibited.

For example, weather detection unit 200 is configured to: determine that the weather is cloudy when weather detection unit 200 has consecutively obtained results of the weather detection that indicate cloudy weather over a first period; and determine that the weather is sunny when weather detection unit 200 has consecutively obtained results of the weather detection that indicate sunny weather over a second period, and the first period is longer than the second period.

Accordingly this inhibits sunny weather from being incorrectly determined to be cloudy, and inhibits functional film 100 from incorrectly operating in the transparent mode in which the transmittance is high. Consequently, this inhibits giving glare to a person in indoor area 21.

For example, weather detection unit 200 is configured to further calculate the reference value for the illuminance and the reference value for the color temperature, based on geographic information and date and time information of the location.

Accordingly the reference value can be changed according to the location at which functional film 100 is installed and the date and time when functional film 100 is controlled. Thus, this allows control suitable for the location and the date and time, and malfunction of functional film 100 can be further inhibited.

### Embodiment 2

The following describes Embodiment 2.

### [Direct Light and Diffuse Light]

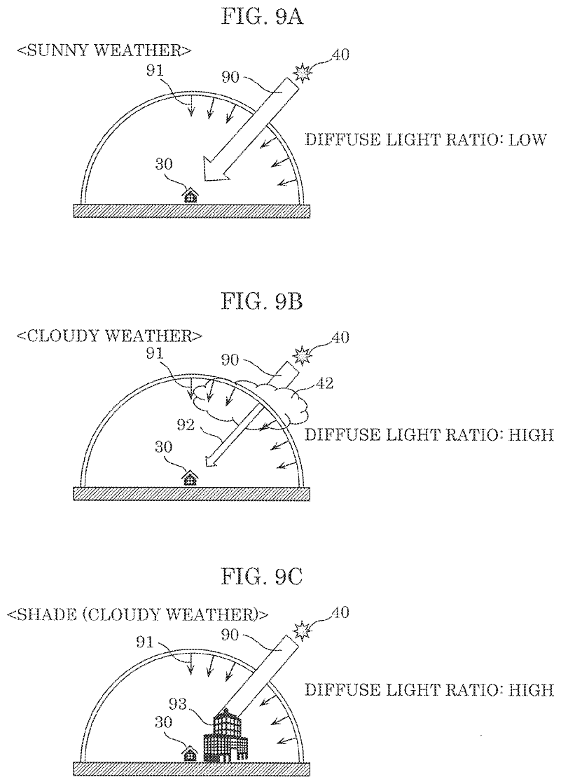

In the present embodiment, the weather is detected using a ratio of direct light and diffuse light. The following first describes direct light and diffuse light, with reference to FIGS. 9A to 9C.

FIGS. 9A to 9C are schematic diagrams illustrating direct light 90 and diffuse light 91 when the weather in the location (building 30) at which functional film 100 according to the present embodiment is installed is sunny, when the weather in the location (building 30) is cloudy and when the location (building 30) is positioned in the shade of building 93, respectively.

Direct light 90 is light which directly travels from sun 40 (solar photosphere) toward functional film 100. Direct irradiance corresponds to irradiance of so-called direct sunlight. Direct irradiance is irradiance on a flat surface perpendicular to the direction in which direct light 90 travels.

Diffuse light 91 is light which enters functional film 100 in a direction other than the direction in which sun 40 is positioned. Diffuse light 91 is light scattered in the sky among light rays from sun 40. Diffuse irradiance is the irradiance of diffuse light 91 which falls on a horizontal plane.

As illustrated in FIG. 9A, when the weather is sunny, there are less blocks such as clouds which block direct light 90, and thus the amount of direct light 90 which reaches building 30 (functional film 100) increases. Accordingly the ratio (diffuse light ratio) of diffuse light 91 to direct light 90 is low.

As illustrated in FIG. 9B, when the weather is cloudy a portion of direct light 90 is interrupted by cloud 42, and thus the amount of direct light 92 which reaches building 30 decreases. Accordingly, the diffuse light ratio is high. Specifically the diffuse light ratio when the weather is cloudy is higher than the diffuse light ratio when the weather is sunny.

As illustrated in FIG. 9C, when building 30 is positioned in the shade although the weather is sunny direct light 90 is blocked by building 93, and thus the diffuse light ratio is high. Accordingly, when functional film 100 is provided in the shade, the weather can be considered to be cloudy.

As described above, the diffuse light ratio differs according to the weather. The daylighting system according to the present embodiment controls functional film 100 based on the diffuse light ratio.

### [Configuration]

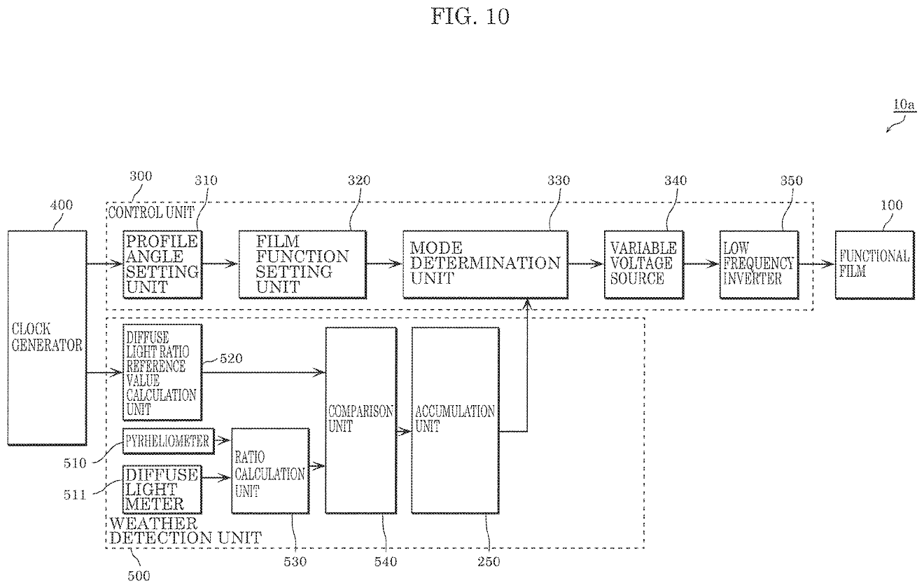

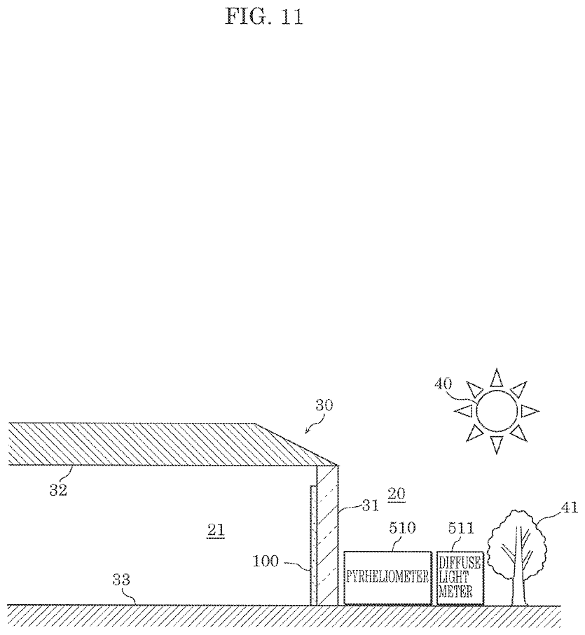

FIG. 10 is a block diagram illustrating a functional configuration of daylighting system 10a according to the present embodiment. FIG. 11 is a schematic diagram illustrating a configuration of daylighting system 10a according to the present embodiment and an example of application thereof.

As illustrated in FIG. 10, daylighting system 10a is different from daylighting system 10 according to Embodiment 1 in that weather detection unit 500 is included instead of weather detection unit 200. The following is a description focusing on differences from Embodiment 1, and omits or simplifies description of common points.

Weather detection unit 500 detects the weather based on a result of comparing a reference value with a ratio of direct light 90 and diffuse light 91 included in light from outdoor area 20. Specifically, weather detection unit 500 determines that the weather is cloudy when a ratio of diffuse irradiance to direct irradiance (diffuse light ratio) is greater than a reference value (a third reference value). Weather detection unit 500 determines that the weather is sunny when the diffuse light ratio is lower than the reference value.

In the present embodiment, as illustrated in FIGS. 10 and 11, weather detection unit 500 includes pyrheliometer 510 and diffuse light meter 511 Weather detection unit 500 calculates a ratio of diffuse irradiance to direct irradiance as the diffuse light ratio. As illustrated in FIG. 10, weather detection unit 500 further includes diffuse light ratio reference value calculation unit 520 and ratio calculation unit 530, comparison unit 540, and accumulation unit 250.

Pyrheliometer 510 is a sensor which detects direct irradiance. Diffuse light meter 511 is a sensor which detects diffuse irradiance. Pyrheliometer 510 and diffuse light meter 511 are, for example, disposed in outdoor area 20 as illustrated in FIG. 11, but may be disposed in indoor area 21.

Diffuse light ratio reference value calculation unit 520 calculates a diffuse light ratio reference value based on geographic information and date and time information. The diffuse light ratio reference value is an example of the third reference value, and is a threshold regarding the diffuse light ratio, which is used when determining whether the weather is sunny or cloudy. For example, the diffuse light ratio reference value is a mean value (or an average) of the average of diffuse light ratios when the weather is sunny and the average of diffuse light ratios when the weather is cloudy.

The diffuse light ratio is the maximum when sun 40 rises or sets, and is the minimum at the culmination time. In addition, the solar altitude changes seasonally, and thus the diffuse light ratio changes seasonally. Specifically, the diffuse light ratio is lower in summer and is higher in winter. Further, the higher the latitude of the location at which functional film 100 is installed is, the lower the solar altitude is, and thus the diffuse light ratio is higher. Accordingly, the diffuse light ratio changes according to the location and date and time, and thus diffuse light ratio reference value calculation unit 520 adjusts the diffuse light ratio reference value to an appropriate value according to the location and date and time. Specifically, diffuse light ratio reference value calculation unit 520 calculates, as the diffuse light ratio reference value, a mean value of an average of diffuse light ratios when the weather is sunny and an average of diffuse light ratios when the weather is cloudy at times for diffuse light ratio comparison in the location at which functional film 100 is installed.

Ratio calculation unit 530 calculates the ratio of diffuse irradiance to direct irradiance as a diffuse light ratio. Specifically ratio calculation unit 530 obtains direct irradiance from pyrheliometer 510 and diffuse irradiance from diffuse light meter 511, and calculates the diffuse light ratio.

Comparison unit 540 compares the diffuse light ratio calculated by ratio calculation unit 530 with the diffuse light ratio reference value calculated by diffuse light ratio reference value calculation unit 520. Comparison unit 540 outputs a cloudy weather signal to accumulation unit 250 when the diffuse light ratio is higher than the diffuse light ratio reference value. Comparison unit 540 outputs a sunny weather signal to accumulation unit 250 when the diffuse light ratio is lower than the diffuse light ratio reference value.

Diffuse light ratio reference value calculation unit 520, ratio calculation unit 530, and comparison unit 540 are implemented by a microcomputer (microcontroller), for example. Specifically the microcomputer includes nonvolatile memory in which a program is stored, volatile memory which is a temporary storage area for executing the program, an input/output port, and a processor which executes the program, for instance. Note that diffuse light ratio reference value calculation unit 520, ratio calculation unit 530, and comparison unit 540 may be constituted by software or hardware.

### [Operation]

Daylighting system 10a according to the present embodiment operates in a similar manner to daylighting system 10 according to Embodiment 1. The illuminance and the color temperature are compared with their respective reference values in Embodiment 1, whereas daylighting system 10a according to the present embodiment compares the diffuse light ratio with the diffuse light ratio reference value.

In the present embodiment, daylighting system 10a operates in accordance with the flowchart illustrated in FIG. 7. Specifically, specific operations in steps S20, S22, S32, and S34 are different from those in Embodiment 1.

In the present embodiment, diffuse light ratio reference value calculation unit 520 calculates the diffuse light ratio reference value in step S20 or S32.

In step S22 or S34, ratio calculation unit 530 calculates the diffuse light ratio, and thereafter comparison unit 540 compares the calculated diffuse light ratio reference value with the diffuse light ratio calculated by ratio calculation unit 530. When the diffuse light ratio is higher than the diffuse light ratio reference value, comparison unit 540 determines that the weather is cloudy. When the diffuse light ratio is lower than the diffuse light ratio reference value, comparison unit 540 determines that the weather is sunny.

Other processing is similar to that of Embodiment 1, and thus according to daylighting system 10a according to the present embodiment, sunny weather can be inhibited from being incorrectly determined to be cloudy weather so that functional film 100 can be inhibited from operating in the transparent mode in which the transmittance is high. Accordingly, glare can be inhibited from being given to a person in indoor area 21.

### [Advantageous Effects and Others]

As described above, daylighting system 10a according to the present embodiment is installed between outdoor area 20 and indoor area 21, and includes: functional film 100 which transmits light from outdoor area 20 to introduce the light to indoor area 21; weather detection unit 500 configured to detect weather in a location at which functional film 100 is installed; and control unit 300 configured to control a transmittance of functional film 100, based on a result of detection by weather detection unit 500. Weather detection unit 500 is configured to detect the weather, based on a result of comparing a reference value with a ratio of direct light 90 and diffuse light 91 which are included in the light from outdoor area 20.

Accordingly, the weather is determined using the ratio of direct light 90 and diffuse light 91, and thus as compared with the case where determination is made using only the illuminance, the weather can be inhibited from being incorrectly determined, and malfunction of functional film 100 can be inhibited.

For example, weather detection unit 500 is configured to determine that the weather is cloudy when a ratio of diffuse irradiance to direct irradiance is greater than a third reference value, and control unit 300 is configured to increase the transmittance of functional film 100 when weather detection unit 500 determines that the weather is cloudy.

Accordingly when the weather is cloudy light can be efficiently introduced to indoor area 21.

For example, weather detection unit 500 includes: pyrheliometer 510 which detects the direct irradiance; and diffuse light meter 511 which detects the diffuse irradiance, and weather detection unit 500 is configured to calculate the ratio of the diffuse irradiance to the direct irradiance.

Accordingly, sensor output from pyrheliometer 510 and sensor output from diffuse light meter 511 can be used as they are, and thus the amount of processing for calculating the diffuse light ratio can be reduced.

Note that the weather is determined using the diffuse light ratio in the present embodiment, yet the present embodiment is not limited thereto. A direct light ratio which is a ratio of direct irradiance to diffuse irradiance may be used.

### Variation 1 of Embodiment 2

Next, Variation 1 of Embodiment 2 is to be described.

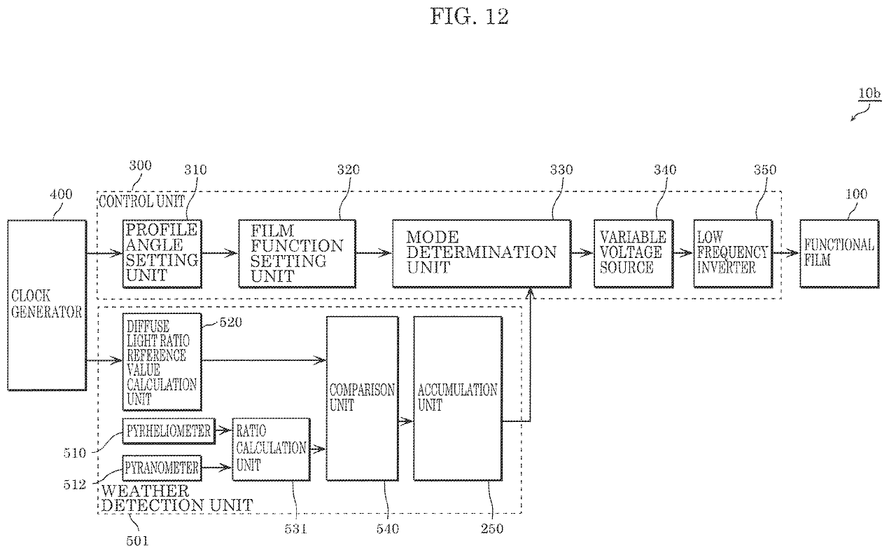

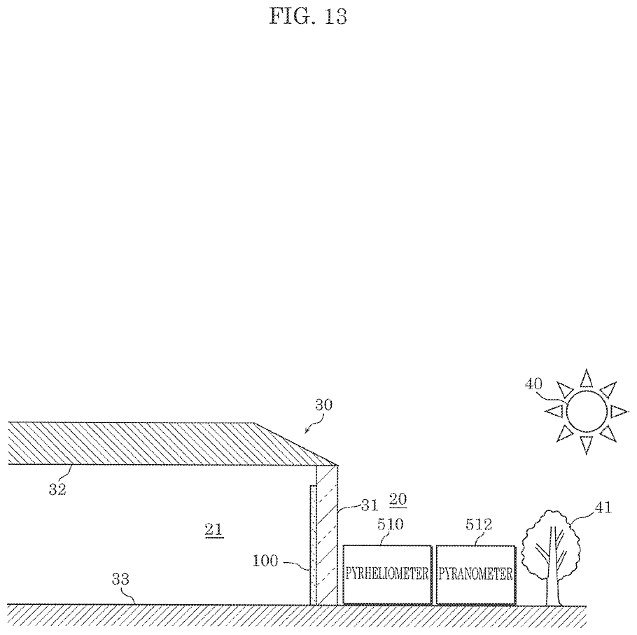

FIG. 12 is a block diagram illustrating a functional configuration of daylighting system 10b according to this variation. FIG. 13 is a schematic diagram illustrating a configuration of daylighting system 10b according to this variation and an example of application thereof.

As illustrated in FIG. 12, daylighting system 10b is different from daylighting system 10a according to Embodiment 2 in that weather detection unit 501 is included instead of weather detection unit 500. The following is a description focusing on differences from Embodiment 2, and omits or simplifies description of common points.

Weather detection unit 501 includes pyrheliometer 510 and pyranometer 512, as illustrated in FIGS. 12 and 13. Pyranometer 512 is a sensor which detects global irradiance. Pyranometer 512 is disposed in outdoor area 20, for example, as illustrated in FIG. 13, but may be disposed in indoor area 21.

Global irradiance is irradiance of light from the entire sky which is a combination of direct light 90 and diffuse light 91. Thus, global irradiance is expressed by a total of direct irradiance and diffuse irradiance. Accordingly, in the present embodiment, weather detection unit 501 subtracts direct irradiance from global irradiance to calculate diffuse irradiance, and calculates a ratio of diffuse irradiance to direct irradiance (diffuse light ratio).

As illustrated in FIG. 12, weather detection unit 501 includes ratio calculation unit 531. Ratio calculation unit 531 obtains direct irradiance from pyrheliometer 510 and global irradiance from pyranometer 512, and calculates diffuse irradiance by subtracting the direct irradiance from the global irradiance. Ratio calculation unit 531 calculates the ratio of the diffuse irradiance to the direct irradiance as the diffuse light ratio.

As described above, in daylighting system 10b according to this variation, weather detection unit 501 includes pyrheliometer 510 which detects direct irradiance and pyranometer 512 which detects global irradiance, calculates diffuse irradiance by subtracting the direct irradiance from the global irradiance, and calculates the ratio of the diffuse irradiance to the direct irradiance.

Accordingly, the diffuse light ratio can be calculated without using diffuse light meter 511, and thus this provides a wider choice of actinometers which can be used.

Note that weather detection unit 501 may also include diffuse light meter 511 instead of pyrheliometer 510. In this case, ratio calculation unit 531 calculates direct irradiance by subtracting diffuse irradiance from global irradiance. Ratio calculation unit 531 calculates the ratio of the diffuse irradiance to the calculated direct irradiance as the diffuse light ratio.

### Variation 2 of Embodiment 2

Next, Variation 2 of Embodiment 2 is to be described.

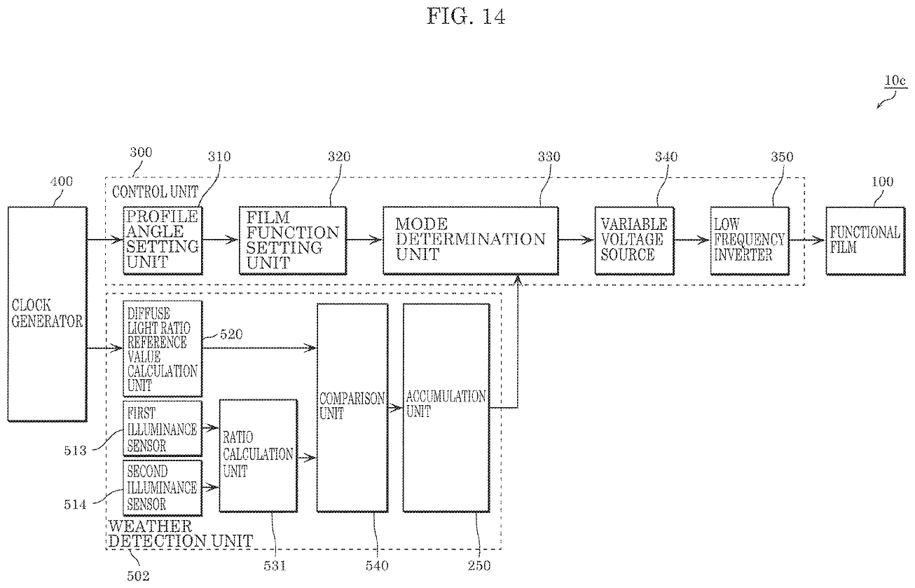

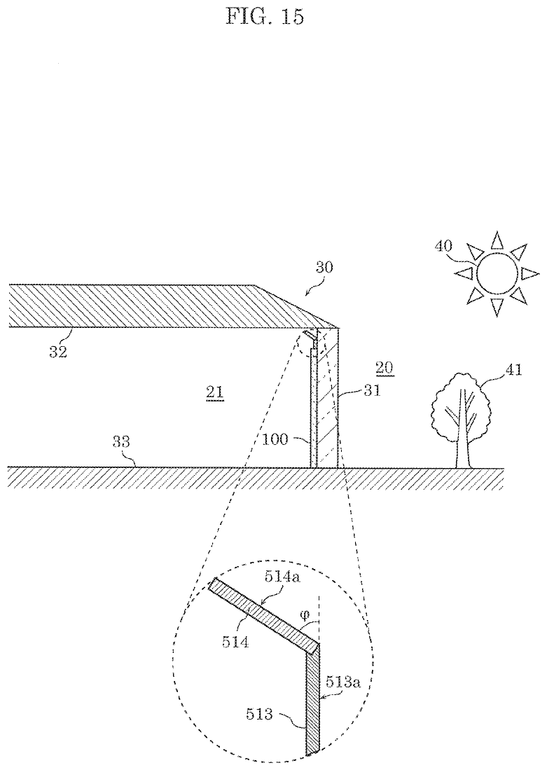

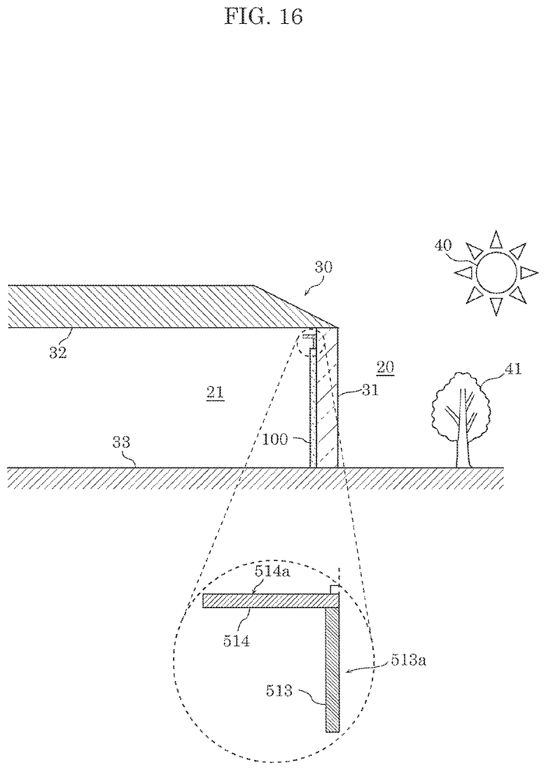

FIG. 14 is a block diagram illustrating a functional configuration of daylighting system 10c according to this variation. FIGS. 15 and 16 are schematic diagrams illustrating configurations of daylighting system 10c according to this variation and examples of application thereof.

As illustrated in FIG. 14, daylighting system 10c is different from daylighting system 10c according to Embodiment 2 in that weather detection unit 502 is included instead of weather detection unit 500. The following is a description focusing on differences from Embodiment 2, and omits or simplifies description of common points.

Weather detection unit 502 includes first illuminance sensor 513 and second illuminance sensor 514, as illustrated in FIGS. 14 to 16. Weather detection unit 502 calculates a ratio of diffuse irradiance to direct irradiance (diffuse light ratio), based on first illuminance detected by first illuminance sensor 513 and second illuminance detected by second illuminance sensor 514.

First illuminance sensor 513 is a sensor which detects illuminance (first illuminance) of light from outdoor area 20. In the present embodiment, as illustrated in 15 and 16, first illuminance sensor 513 is disposed so that a light-receiving surface is horizontal to a vertical direction. Thus, light-receiving surface 513a of first illuminance sensor 513 is parallel to a light-entering surface (principal surface of first substrate 110) of functional film 100.

Second illuminance sensor 514 is a sensor which detects illuminance (second illuminance) of light from outdoor area 20. As illustrated in FIGS. 15 and 16, second illuminance sensor 514 is disposed tilted by a predetermined angle relative to first illuminance sensor 513.

Note that the predetermined angle differs in magnitude in FIGS. 15 and 16. Second illuminance sensor 514 illustrated in FIG. 15 is disposed such that angle φ formed between light-receiving surface 514a and light-receiving surface 513a of first illuminance sensor 513 is an acute angle. Second illuminance sensor 514 illustrated in FIG. 16 is disposed such that angle φ formed between light-receiving surface 514a and light-receiving surface 513a is 90 degrees. Specifically in FIG. 16, light-receiving surface 514a of second illuminance sensor 514 is horizontal to the ground.

In this variation, first illuminance sensor 513 and second illuminance sensor 514 are disposed in indoor area 21, but may be disposed in outdoor area 20.

As illustrated in FIG. 14, weather detection unit 502 includes ratio calculation unit 531. Ratio calculation unit 531 calculates a ratio of diffuse irradiance to direct irradiance as a diffuse light ratio. Specifically, ratio calculation unit 530 obtains first illuminance from first illuminance sensor 513 and second illuminance from second illuminance sensor 514, and calculates the diffuse light ratio based on the first illuminance and the second illuminance.

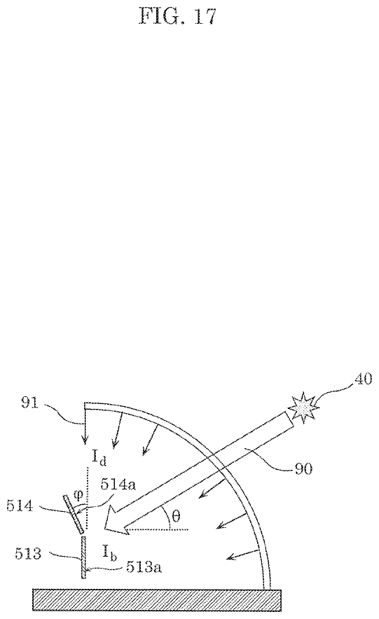

Here, a specific method of calculating the diffuse light ratio is to be described with reference to FIG. 17. FIG. 17 is a schematic diagram illustrating a relation between the solar altitude and the orientation of the illuminance sensor according to this variation. As illustrated in FIG. 17, the angle of incidence of direct light 90 on light-receiving surface 513a of first illuminance sensor 513 is θ, and the angle of tilt of light-receiving surface 514a of second illuminance sensor 514 relative to the vertical direction is φ. The irradiance (direct normal irradiance) of direct light 90 on the vertical plane is I_{b}, and the irradiance (diffuse horizontal irradiance) of diffuse light 91 on the horizontal plane is I_{d}. Furthermore, the first illuminance detected by first illuminance sensor 513 is I_{G1}, and the second illuminance detected by second illuminance sensor 514 is I_{G2}. At this time, Expressions (1) and (2) below are satisfied.

[Math 1]

I_{G1}=I_{b} cos θ+I_{d} (1)

I_{G2}=I_{b} cos(θ−ϕ)+I_{d} (2)

I_{b} and I_{d} are calculated by Expressions (3) and (4) below by rearranging Expressions (1) and (2) above.

$$\begin{matrix}[ Math . 2 ] & \\ {I}_{b} = \frac{{I}_{G 2} - {I}_{G 1}}{cos ( θ–φ ) - cos θ} & ( 3 ) \\ {I}_{d} = \frac{{I}_{G 1} cos ( θ - φ ) - {I}_{G 2} cos θ}{cos ( θ - φ ) - cos θ} & ( 4 )\end{matrix}$$

In particular, as illustrated in FIG. 16, when φ=90°, I_{b} and I_{d} are calculated by Expressions (5) and (6) below

$$\begin{matrix}[ Math 3 ] & \\ {I}_{b} = \frac{{I}_{G 2} - {I}_{G 1}}{sin θ - cos θ} & ( 5 ) \\ {I}_{d} = \frac{{I}_{G 1} sin θ - {I}_{G 2} cos θ}{sin θ - cos θ} & ( 6 )\end{matrix}$$

As described above, in daylighting system 10c according to this variation, for example, weather detection unit 502 includes: first illuminance sensor 513 which detects a first illuminance of the light from outdoor area 20; and second illuminance sensor 514 which is disposed tilted by a predetermined angle relative to first illuminance sensor 513, and detects a second illuminance of the light from outdoor area 20, and weather detection unit 502 is configured to calculate the ratio of the diffuse irradiance to the direct irradiance, based on the first illuminance and the second illuminance.

Accordingly, the diffuse light ratio can be calculated using two illuminance sensors. The illuminance sensors have a simple configuration and are small and inexpensive, as compared with pyrheliometer 510, diffuse radiation meter 511, and pyranometer 512, for instance. Thus, daylighting system 10c can be achieved using a simple configuration.

For example, the predetermined angle is 90 degrees.

Accordingly the amount of processing for calculating the diffuse light ratio can be reduced.

For example, weather detection unit 502 may calculate atmospheric transmittance P based on the direct irradiance, and may detect the weather, based on the result of comparing calculated atmospheric transmittance P with a reference value.

Atmospheric transmittance P indicates a proportion of sunrays that pass through. Thus, it means that the closer atmospheric transmittance P is to 1, the more the amount of sunlight which directly reaches the ground (the amount of direct light) is, whereas the closer atmospheric transmittance P is to 0, the less the amount of direct light is. Accordingly weather detection unit 502 can detect weather by comparing atmospheric transmittance P with a predetermined reference value. For example, weather detection unit 502 may determine that the weather is cloudy when atmospheric transmittance P is less than or equal to 0.5, and may determine that the weather is sunny when atmospheric transmittance P is higher than 0.5. Note that the reference value may not be 0.5, but 0.6 or 0.4, for instance.

Atmospheric transmittance P satisfies the Bouguer formula indicated by Expression (7) below.

$$\begin{matrix}[ Math 4 ] & \\ {I}_{b} = {I}_{0} {P}^{\frac{1}{sinh}} & ( 7 )\end{matrix}$$

Here, I₀ corresponds to a solar constant, and is normally 1.37 kW/m². Further, h is a solar altitude. Accordingly, weather detection unit 502 calculates irradiance I_{b} of direct light 90 on the vertical plane based on Expression (3) or (5), to calculate atmospheric transmittance P based on Expression (7).

Note that an example in which irradiance I_{b} is calculated based on the results of detection by first illuminance sensor 513 and second illuminance sensor 514 is described herein, yet the result of detection by pyrheliometer 510 may be used. Direct irradiance I_{b} may be calculated using the results of detection by diffuse light meter 511 and pyranometer 512.

Accordingly, the atmospheric transmittance can be calculated using two illuminance sensors. Alternatively, the atmospheric transmittance can be calculated using only pyrheliometer 510. Accordingly the daylighting system can be achieved using a simple configuration.

### Embodiment 3

### [Outline]

As described in Embodiment 1 above, control unit 300 can switch between the automatic mode for controlling the transmittance of functional film 100 based on a result of detection by weather detection unit 200 and the manual mode for controlling the transmittance of functional film 100 based on a user operation.

A user switches between the two control modes, namely the automatic mode and the manual mode, by operating a user interface such as an operation panel which receives a user operation, for example. Typically, the installation of an operation panel requires large-scale construction such as embedding the operation panel in a structure near a window.

In view of this, Embodiment 3 is to describe a daylighting system for which the scale of the construction for installing a user interface such as an operation panel is reduced.

Note that in the description of Embodiment 3 and the drawings used for the description, the X axis, the Y axis, and the Z axis represent three axes of a three-dimensional orthogonal coordinate system. In Embodiment 3, the Z-axis direction is a vertical direction, and a direction perpendicular to the Z axis (a direction parallel to the X-Y plane) is a horizontal direction. The X axis and the Y axis are orthogonal to each other and are both orthogonal to the Z axis. The positive Z-axis direction is defined as a vertically downward direction. In Embodiment 3, a “plan view” is a view in a direction perpendicular to the principal surface of the first substrate or the second substrate.

### [Overall Configuration]

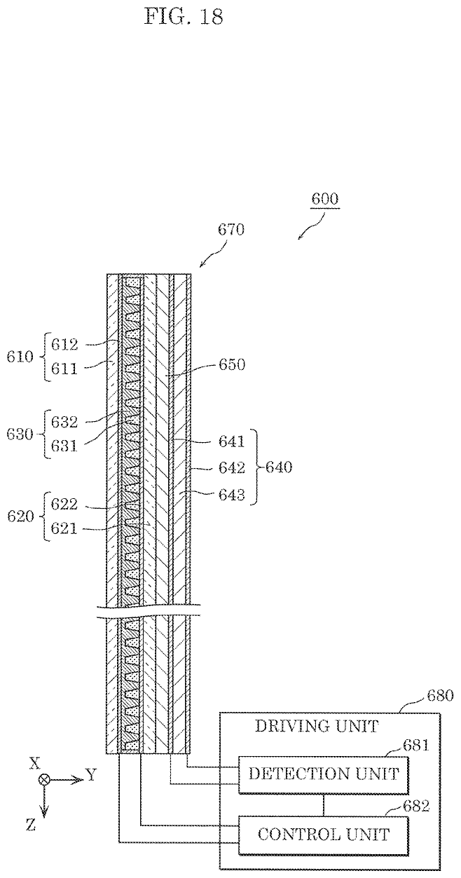

First, a configuration of the daylighting system according to Embodiment 3 is to be described with reference to FIG. 18. FIG. 18 illustrates a configuration of the daylighting system according to Embodiment 3. FIG. 18 illustrates a cross section of functional film 670.

Daylight system 600 is a light control device which controls light which enters functional film 670. In other words, daylighting system 600 is a light distribution control system and, in other words, functional film 670 is an optical device. Specifically daylighting system 600 is a light distribution controlling element which can change the travel direction of light which enters functional film 670 (that is, can distribute the light) and causes the light to exit. Although not illustrated, functional film 670 is a sheet which has a principal surface parallel to the Z-X plane, and is installed on, for instance, a window and used. FIG. 18 is a cross-sectional view of functional film 670 taken along the plane orthogonal to the principal surface.

As illustrated in FIG. 18, daylighting system 600 specifically includes functional film 670 and driving unit 680. Functional film 670 includes first film substrate 610, second film substrate 620, light distribution layer 630, touch-panel layer 640, and adhesive layer 650. Driving unit 680 includes detection unit 681 and control unit 682. The following describes such elements in detail.

### [First Film Substrate, Second Film Substrate]

First film substrate 610 is a light-transmitting substrate, and includes first substrate 611 and first electrode 612. First electrode 612 is disposed on one principal surface of first substrate 611. Second film substrate 620 is a light-transmitting substrate, and includes second substrate 621 and second electrode 622. Second electrode 622 is disposed on one principal surface of second substrate 621.

First film substrate 610 and second film substrate 620 are disposed with a predetermined space therebetween in such a manner that first electrode 612 included in first film substrate 610 and second electrode 622 included in second film substrate 620 face each other. Specifically first film substrate 610 and second film substrate 620 are counter substrates facing each other.

First substrate 611 and second substrate 621 are formed using a light-transmitting material. First substrate 611 and second substrate 621 are formed using a resin material, for example. Specific resin materials include polyethylene terephthalate (PET), polyethylene naphthalate (PEN), polycarbonate (PC), polystyrene (PS), polyvinyl alcohol (PVA), triacetyl cellulose (TAC), acrylic (PMMA), and epoxy, for instance.

First substrate 611 and second substrate 621 may not be formed using a sheet shaped rigid material. First substrate 611 and second substrate 621 may be formed using a film-shaped flexible material. Examples of rigid material include PC and PMMA, and examples of flexible material include PET, PEN, PS, PVA, and TAC.

Note that first substrate 611 and second substrate 621 may be formed using a glass material such as soda glass, alkali free glass, or high refractive index glass. First substrate 611 and second substrate 621 may be made of the same material or different materials.

Note that first substrate 611 and second substrate 621 each have, for example, a quadrilateral shape (a square or rectangular shape) in a plan view. The shape, however, is not limited to those, and may be a round or a polygon other than a quadrilateral. An arbitrary shape may be employed. In Embodiment 3, first substrate 611 and second substrate 621 are formed using PET.

First electrode 612 is disposed between first substrate 611 and light distribution layer 630. Specifically, first electrode 612 is formed on the one principal surface of first substrate 611 (principal surface on the light distribution layer 630 side). First electrode 612 is a solid electrode, and is formed into a thin film on substantially the entire one principal surface of first substrate 611. In other words, first electrode 612 is a first electrode layer.

On the other hand, second electrode 622 is disposed between light distribution layer 630 and second substrate 621. Specifically, second electrode 622 is formed on the one principal surface of second substrate 621 (principal surface on the light distribution layer 630 side). Second electrode 622 is a solid electrode, and is formed into a thin film on substantially the entire one principal surface of second substrate 621. In other words, second electrode 622 is a second electrode layer.

First electrode 612 and second electrode 622 electrically form a pair, and can apply an electric field to light distribution layer 630. Changing a voltage applied to first electrode 612 and second electrode 622 changes the orientations of liquid crystal molecules included in liquid crystal portion 632 of light distribution layer 630. Accordingly, the refractive index of liquid crystal portion 632 can be changed.

First electrode 612 and second electrode 622 are formed using a light-transmitting and conductive material. Examples of such a material include transparent metal oxides such as indium tin oxide (ITO), indium zinc oxide (IZO), zinc oxide (ZnO), gallium doped zinc oxide (GZO) obtained by doping ZnO with gallium (Ga), and aluminum doped zinc oxide (AZO) obtained by doping ZnO with aluminum (Al), an electric conductor containing resin made of a resin that contains electric conductors such as silver nanowire and conductive particles, and a thin metal film such as a silver film. Note that first electrode 612 and second electrode 622 may each have a structure which includes a single layer made of such a material, or a structure in which layers made of such materials are stacked (for example, a structure in which a transparent metal oxide and a metal thin film are stacked).

Note that alignment films which align the orientation of liquid crystal molecules in liquid crystal portion 632 of light distribution layer 630 may be formed on the surfaces of first film substrate 610 and second film substrate 620. An alignment film is formed on the surface of first electrode 612 of first film substrate 610 on the light distribution layer 630 side, for example. An alignment film may be subjected to orientation processing such as rubbing processing or optical processing, or may be an inorganic orientation film made of a SiO₂ film which does not require orientation processing. An alignment film may be formed on the surface of protruding and recessed structure 631. When an alignment film is formed on protruding and recessed structure 631, the alignment film may be a photo-alignment film obtained by optical processing or an inorganic orientation film formed by dry coating such as sputtering, in order to prevent protruding and recessed structure 631 from deteriorating or being damaged.

### [Light Distribution Layer]

Light distribution layer 630 is a light-transmitting layer, and transmits light which has entered. In addition, light distribution layer 630 can distribute the light which has entered. Thus, light distribution layer 630 can change the travel direction of light passing through Light distribution layer 630. In other words, light distribution layer 630 is a light controlling layer.

Light distribution layer 630 is disposed between first electrode 612 and second electrode 622, and includes protruding and recessed structure 631 and liquid crystal portion 632. Protruding and recessed structure 631 and liquid crystal portion 632 are in contact with each other.

Protruding and recessed structure 631 includes a plurality of protrusions of a micro-order or nano-order size. In other words, protruding and recessed structure 631 is a protruding and recessed layer. The protrusions protrude from the first electrode 612 side toward second electrode 622. The protrusions are formed into stripes. Specifically the protrusions are each shaped into an elongated substantially quadrilateral prism having a trapezoid cross-sectional shape and extending in the X axial direction, and are disposed at equal intervals in the Z axial direction. The height of each protrusion is in a range from 100 μm to 100 μm, for example. The interval of adjacent protrusions is a predetermined interval of 100 μm or shorter, for example.

The protrusions each have a cross-sectional shape tapered from first film substrate 610 toward second film substrate 620. A pair of lateral surfaces which one protrusion has are tilted by a predetermined angle relative to the thickness direction, and the distance between the pair of lateral surfaces (the width of the protrusion) gradually decreases from second film substrate 620 toward first film substrate 610. Note that the shape of the protrusions is not limited to a substantially quadrilateral prism, and may be a substantially triangular prism having a triangular cross-sectional shape or other shapes.

The lateral surfaces of a protrusion each define an interface between the protrusion and liquid crystal portion 632. Light which has entered protruding and recessed structure 631 from the first film substrate 610 side is reflected off and refracted by a lateral surface of a protrusion (the interface between the protrusion and liquid crystal portion 632), according to a difference in refractive index between protruding and recessed structure 631 and liquid crystal portion 632, or passes through as it is without being reflected and refracted. Note that in protruding and recessed structure 631, adjacent protrusions are connected to each other by the root portion, but may be separated.

The material of protruding and recessed structure 631 (protrusions) is a light-transmitting resin material such as an acrylic resin, an epoxy resin, or a silicone resin, for example. Protruding and recessed structure 631 can be formed by molding or nanoimprinting, for example. In Embodiment 3, protruding and recessed structure 631 (protrusions) is made of an acrylic resin having a refractive index of 1.5.

Liquid crystal portion 632 is in a space defined by the protrusions (recesses) of protruding and recessed structure 631. In other words, liquid crystal portion 632 is a liquid crystal layer, and is an example of a refractive-index control layer. Liquid crystal portion 632 is made of a liquid crystal material which includes liquid crystal molecules. Examples of such a liquid crystal material include a nematic liquid crystal or a cholesteric liquid crystal in which liquid crystal molecules are rod-shaped. Note that the liquid crystal material may be a twist nematic liquid crystal (TN liquid crystal) material, for instance.

The liquid crystal molecules of liquid crystal portion 632 exhibit birefringence. In Embodiment 3, the refractive index of protruding and recessed structure 631 is 1.5, and thus a positive-type liquid crystal material having an ordinary index (no) of 1.5 and an extraordinary index (ne) of 1.7 is used for liquid crystal portion 632. Note that a negative-type liquid crystal material may be used for liquid crystal portion 632.

Liquid crystal portion 632 functions as a refractive-index control layer having a refractive index controllable for light in a visible light range by the application of an electric field. Specifically, liquid crystal portion 632 is made of a liquid crystal having liquid crystal molecules responsive to an electric field, and thus the application of an electric field to liquid crystal portion 632 (that is, the application of a voltage to first electrode 612 and second electrode 622) changes the orientations of the liquid crystal molecules so that the refractive index of liquid crystal portion 632 changes.

Note that an edge portion of protruding and recessed structure 631 which is between first film substrate 610 and second film substrate 620 is sealed by a sealant so as to prevent liquid crystal portion 632 from leaking to the outside.

### [Touch-Pane Layer]

Touch-panel layer 640 is a substrate for providing functional film 670 with a touch-panel function, and receives a touch operation made by a user. Touch-panel layer 640 is bonded to second film substrate 620 (another principal surface of second substrate 621) by adhesion layer 650. In a plan view, touch-panel layer 640 may have the same size as that of second film substrate 620, or may be smaller than second film substrate 620. Stated differently touch-panel layer 640 may be formed on a partial region (formed partially) of the other principal surface of second substrate 621. Touch-panel layer 640 includes third electrode 641, fourth electrode 642, and intermediate layer 643, and is formed by stacking these three layers.

Third electrode 641 and fourth electrode 642 are disposed on the second film substrate 620 side of functional film 670. Stated differently second substrate 621 is located between second electrode 622 and third electrode 641. Third electrode 641 and fourth electrode 642 are stacked via intermediate layer 643 (an air layer or a dielectric layer). Intermediate layer 643 is an insulating layer.

Third electrode 641 is disposed on one principal surface of intermediate layer 643. Third electrode 641 is a solid electrode, and is formed into a thin film on substantially the entire one principal surface of intermediate layer 643. In other words, third electrode 641 is a third electrode layer. Third electrode 641 may be a mesh electrode, rather than a solid electrode. The surface of third electrode 641. (the surface on the side opposite intermediate layer 643) is a surface which functions as an adhesion surface of touch-panel layer 640, and on which adhesion layer 650 is formed.

Fourth electrode 642 is disposed on another principal surface of intermediate layer 643. Fourth electrode 642 is a solid electrode, and is formed on the other principal surface of intermediate layer 643. Fourth electrode 642 is a solid electrode, and is formed into a thin film on substantially the entire other principal surface of intermediate layer 643. In other words, fourth electrode 642 is a fourth electrode layer. Fourth electrode 642 may be a mesh electrode, rather than a solid electrode. The surface of the electrode 642 (the surface on the side opposite intermediate layer 643) is a surface on which a touch operation is made by a user. Note that a light-transmitting protective cover may be disposed on the surface of fourth electrode 642.

Third electrode 641 and fourth electrode 642 are used as a pair of detection electrodes by detection unit 681 included in driving unit 680. Third electrode 641 and fourth electrode 642 are formed using a light-transmitting and conductive material. Examples of such a material include transparent metal oxides such as ITO, ZnO, GZO obtained by doping ZnO with Ga, and AZO obtained by doping ZnO with Al, an electric conductor containing resin made of a resin that contains electric conductors such as silver nanowire and conductive particles, and a thin metal film such as a silver film. Note that third electrode 641 and fourth electrode 642 may each have a structure which includes a single layer made of such a material, or a structure in which layers made of such materials are stacked (for example, a structure in which a transparent metal oxide and a metal thin film are stacked).

Intermediate layer 643 is a layer for securing insulation between third electrode 641 and fourth electrode 642. Intermediate layer 643 is formed using a light-transmitting dielectric, for example. Intermediate layer 643 may be an air layer, and in this case, spacers for securing the space between third electrode 641 and fourth electrode 642 are partially disposed on intermediate layer 643. The spacers may be formed using a light-transmitting resin material, for example.

Adhesion layer 650 is a layer formed using a light-transmitting adhesive, and is used in order to bond touch-panel layer 640.

### [Driving Unit (Detection Unit and Control Unit)]

Driving unit 680 is a drive which switches whether to apply a voltage between first electrode 612 and second electrode 622, based on a user operation on functional film 670 (touch-panel layer 640). Specifically, driving unit 680 includes detection unit 681 and control unit 682. Driving unit 680 may be implemented as a device separate from functional film 670 or alternatively, a portion or the entirety of driving unit 680 may be included in functional film 670.

Detection unit 681 is a detector element which detects a user operation on functional film 670, and outputs a signal to control unit 682 according to a detection result. In daylighting system 600, detection unit 681 detects a user operation on touch-panel layer 640. Detection unit 681 detects a user operation, using third electrode 641 and fourth electrode 642 as a pair of detection electrodes.

Detection unit 681 may be implemented by a circuit (detection circuit), for example, but may be implemented by a microcomputer or a processor. Detection unit 681 may be implemented by a combination of two or more of a circuit, a microcomputer, and a processor. Detection unit 681 is electrically connected with third electrode 641 and fourth electrode 642 (terminal portions) which are exposed from an edge portion of functional film 670.

Control unit 682 includes a voltage applying circuit which applies a voltage between first electrode 612 and second electrode 622, based on an operation (signal output from detection unit 681) detected by detection unit 681. In other words, control unit 682 is a voltage applying unit. Specifically, control unit 682 switches between a voltage applying state in which a voltage is applied between first electrode 612 and second electrode 622 and a no-voltage applying state in which the application of a voltage between first electrode 612 and second electrode 622 is stopped, each time a touch operation made by a user on touch-panel layer 640 is detected.

In the voltage applying state, control unit 682 applies, between first electrode 612 and second electrode 622, an AC voltage having a square waveform and a frequency of about 100 Hz, for example. Control unit 682 is implemented by an insulating power converter circuit which converts an AC voltage supplied from an electric power system into an AC voltage having a square waveform as mentioned above and outputs the resultant voltage, for example. The power converter circuit includes a variable voltage source and a low frequency inverter circuit, for instance. Control unit 682 is electrically connected with first electrode 612 and second electrode 622 (terminal portions) which are exposed from an edge portion of functional film 670.

Note that in the voltage applying state, control unit 682 may apply an AC voltage having a sine-wave waveform between first electrode 612 and second electrode 622 or apply a DC voltage. Alternatively, control unit 682 may apply a minute AC voltage also in the no-voltage applying state.

As described in Embodiments 1 and 2 above, when daylighting system 600 supports switching between the automatic mode based on the result of detection by weather detection unit 200 and the manual mode based on a user operation, control unit 682 may switch between the automatic mode and the manual mode based on the operation detected by detection unit 681. In this case, in the manual mode, control unit 682 may control the transmittance of functional film 670 based on the operation detected by detection unit 681. Note that a detailed configuration of control unit 682 when daylighting system 600 supports switching between the automatic mode and the manual mode is a similar configuration to that of control unit 300, for example.

### [Operation of Daylighting System]

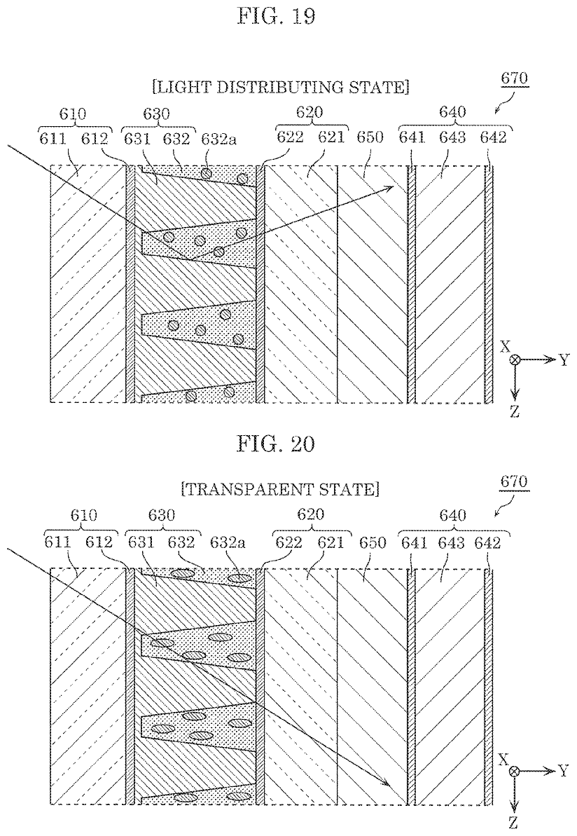

Next, operation of daylighting system 600 is to be described. Functional film 670 included in daylighting system 600 is brought into a first mode in the no-voltage applying state in which a voltage is not applied to first electrode 612 and second electrode 622, and into a second mode in the voltage applying state in which a voltage is applied between first electrode 612 and second electrode 622. FIG. 19 is a diagram for describing the travel direction of light which has entered functional film 670 in the first mode, and FIG. 20 is a diagram for describing the travel direction of light which has entered functional film 670 in the second mode. FIG. 19 and FIG. 20 are equivalent to partially enlarged diagrams of FIG. 18.

First, the first mode is to be described. In Embodiment 3, liquid crystal portion 632 is made of a positive-type liquid crystal material having an extraordinary index of 1.7 and an ordinary index of 1.5. The refractive index of protruding and recessed structure 631 is 1.5. In functional film 670 in the first mode, liquid crystal molecules 632a of liquid crystal portion 632 are oriented horizontally to first film substrate 610 and second film substrate 620, and the refractive index of liquid crystal portion 632 is 1.7. In this case, there is a difference in refractive index between protruding and recessed structure 631 and liquid crystal portion 632.

Accordingly, as illustrated in FIG. 19, incident light (for example, sunlight) which obliquely enters functional film 670 in the first mode is totally reflected off the interface between protruding and recessed structure 631 and liquid crystal portion 632 (the upper lateral surface of a protrusion of protruding and recessed structure 631) so that the travel direction is bent, and the light exits from functional film 670 to the outside.

On the other hand, in functional film 670 in the second mode, liquid crystal molecules 632a of liquid crystal portion 632 are in perpendicular orientation in which liquid crystal molecules 632a are oriented perpendicularly to first film substrate 610 and second film substrate 620. In this case, the refractive index of liquid crystal portion 632 is 1.5, and there is no difference in refractive index between protruding and recessed structure 631 and liquid crystal portion 632.

Accordingly as illustrated in FIG. 20, incident light which obliquely enters functional film 670 in the second mode travels straight without being refracted by or reflected off the interface between protruding and recessed structure 631 and liquid crystal portion 632 and exits from functional film 670 to the outside.

Accordingly functional film 670 is an active-type light control device in which whether the refractive indices of protruding and recessed structure 631 and liquid crystal portion 632 match changes due to a voltage (electric field).

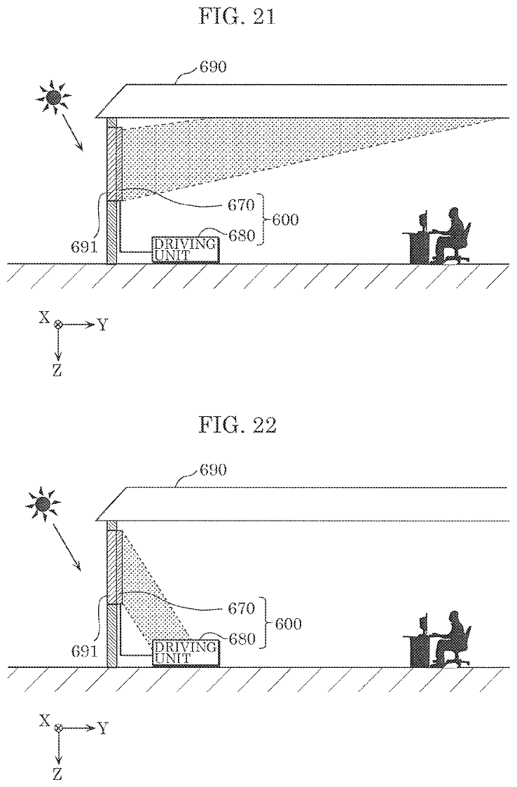

Functional film 670 is applied onto a window, for example, and is used. FIGS. 21 and 22 are diagrams illustrating examples of use of an optical device.

As illustrated in FIGS. 21 and 22, functional film 670 is installed on window 691 of building 690, thus providing window 691 with a light distribution function. Functional film 670 is applied onto window 691 on the indoor side via an adhesive layer, for example. At this time, functional film 670 is disposed such that first film substrate 610 is on the outdoor side and second film substrate 620 is on the indoor side.

As illustrated in FIG. 21, functional film 670 in the first mode directs sunlight toward the ceiling of the room of building 690. On the other hand, as illustrated in FIG. 22, functional film 670 in the second mode directs sunlight to the floor surface of the room of building 690.

As mentioned above, the first mode and the second mode are switched each time a user touches touch-panel layer 640, for example. Accordingly, functional film 670 includes touch-panel layer 640 which receives a user operation, and thus when daylighting system 600 is installed in building 690, construction for installing an operation panel to building 690 can be omitted. Accordingly, this achieves daylighting system 600 for which the scale of such installation construction is reduced.

Note that in FIGS. 21 and 22, driving unit 680 is disposed on the floor of the room, yet the location of driving unit 680 is not limited in particular. Driving unit 680 may be installed on the wall or pillar of building 690 or may be embedded in the wall or the pillar.

### [Types of Touch Panel]

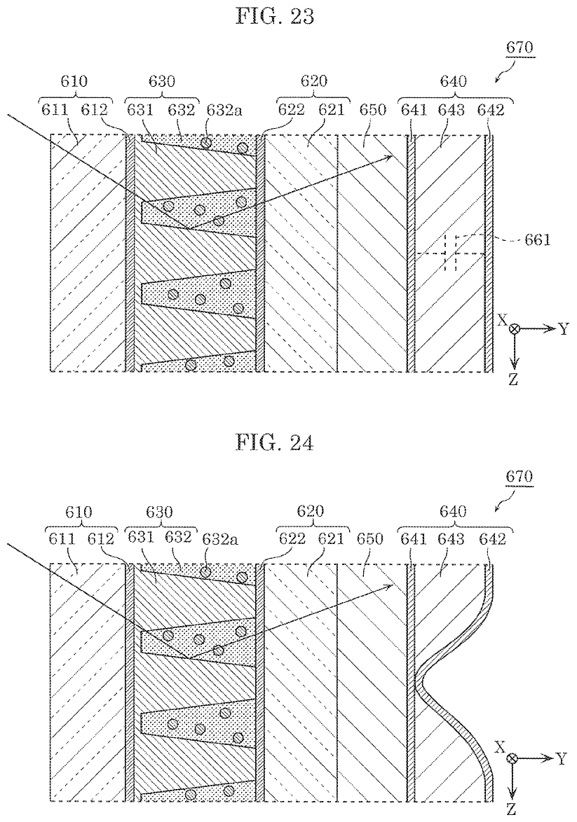

Touch-panel layer 640 is a capacitive touch panel, for example. FIG. 23 schematically illustrates capacitive touch-panel layer 640.

When touch-panel layer 640 is of a capacitive type, intermediate layer 643 is a dielectric layer. As illustrated in FIG. 23, parasitic capacitance 661 is present between third electrode 641 and fourth electrode 642. When a user touches fourth electrode 642 (or when a user's hand approaches fourth electrode 642), capacitance generated between fourth electrode 642 and the user changes the capacitance between third electrode 641 and fourth electrode 642 to capacitance different from parasitic capacitance 661.

In this case, detection unit 681 uses third electrode 641 and fourth electrode 642 as a pair of detection electrodes, and detects the change in capacitance between the pair of detection electrodes as a user operation.

Examples of the capacitive type include a self-capacitive type and a mutual capacitive type. When the self-capacitive type is adopted, third electrode 641 is used as a ground electrode, and detection unit 681 detects an increase in the capacitance between third electrode 641 and fourth electrode 642 as a user operation. Specifically, detection unit 681 applies a detection signal (for example, a rectangular pulse) to third electrode 641, and can detect an increase in capacitance, based on a change in the waveform of the detection signal (or a waveform of an electric current based on the detection signal).

On the other hand, when the mutual capacitive type is adopted, third electrode 641 is used as a reception electrode, and fourth electrode 642 is used as a transmission electrode. Detection unit 681 forms an electric field between third electrode 641 and fourth electrode 642 by applying a detection signal (for example, a rectangular pulse) to fourth electrode 642 (a transmission electrode). If a user touches fourth electrode 642 (or if a user's hand approaches fourth electrode 642), a portion of the electric field moves to the user. Specifically the electric field between third electrode 641 and fourth electrode 642 decreases. Accordingly the capacitance between third electrode 641 and fourth electrode 642 decreases. Detection unit 681 detects, as a user operation, a decrease in capacitance between third electrode 641 and fourth electrode 642 (a decrease in the electric field). Specifically detection unit 681 can detect a decrease in capacitance, based on a change in the waveform of the detection signal (or a waveform of an electric current based on the detection signal).

Touch-panel layer 640 may be a resistive touch panel. FIG. 24 schematically illustrates resistive touch-panel layer 640.

When touch-panel layer 640 is of a resistive type, intermediate layer 643 is an air layer and spacers for maintaining third electrode 641 and fourth electrode 642 in an insulated state are disposed on intermediate layer 643. If a user presses fourth electrode 642, third electrode 641 and fourth electrode 642 are brought into contact with each other as illustrated in FIG. 24.

In this case, detection unit 681 uses third electrode 641 and fourth electrode 642 as a pair of detection electrodes, and detects contact of the pair of detection electrodes as a user operation.

### [Detection Target Periods]

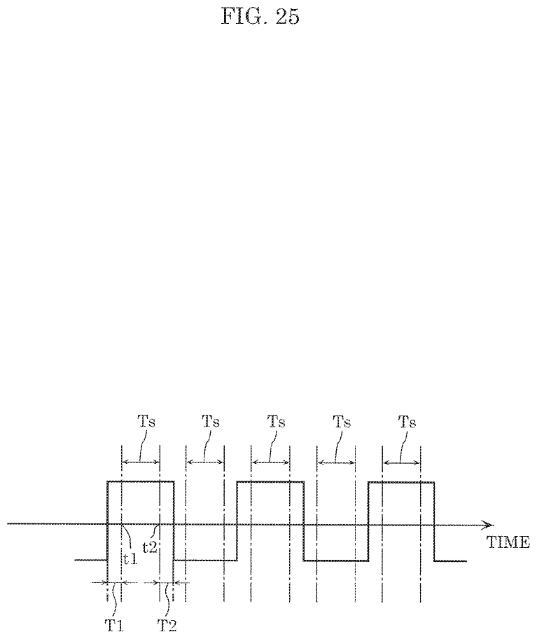

Detection unit 681 may detect user operations constantly or in limited periods. For example, detection unit 681 may selectively detect a user operation only in a detection target period, and may regard a user operation made in a period other than the detection target period as invalid. FIG. 25 illustrates examples of detection target periods.

As illustrated in FIG. 25, in the voltage applying state (the first mode) in which a square-wave AC voltage is applied between first electrode 612 and second electrode 622, detection target period Ts is a period from first timing t1 to second timing t2, for example. First timing t1 is a timing when first predetermined period T1 has elapsed from a timing at which the polarity of the AC voltage applied by control unit 682 between first electrode 612 and second electrode 622 changes (a timing at which the waveform crosses the zero level axis for an n-th time (n is a natural number)). Second timing t2 is a timing prior to the timing at which the polarity of the AC voltage changes next (a timing at which the waveform crosses the zero level axis for an n+1-th time) by second predetermined period T2. The length of first predetermined period T1 and the length of second predetermined period T2 may be the same or different. The length of first predetermined period T1 and the length of second predetermined period T2 may be determined experientially or experimentally, as appropriate.

In this manner, if detection unit 681 selectively detects a user operation only in detection target period Ts, a period when noise is readily generated, which includes a timing at which the polarity changes (a timing at which the waveform crosses the zero level axis), is excluded from detection target period Ts. Accordingly, this reduces the influence of noise on detection by detection unit 681, and inhibits incorrect detection. When touch-panel layer 640 is of a capacitive type, a change in the capacitance detected by detection unit 681 is susceptible to the influence of noise, and thus such a detection method is useful in particular.

Note that in the no-voltage applying state (the second mode), detection unit 681 constantly detects user operations. When a minute AC voltage is applied in the no-voltage applying state, detection unit 681 may selectively detect user operations only in detection target periods Ts also in the no-voltage applying state (the second mode).

Note that the configuration of selectively detecting user operations only in such detection target periods Ts may be implemented by hardware such as a circuit or by software.

### Variation 1 of Embodiment 3

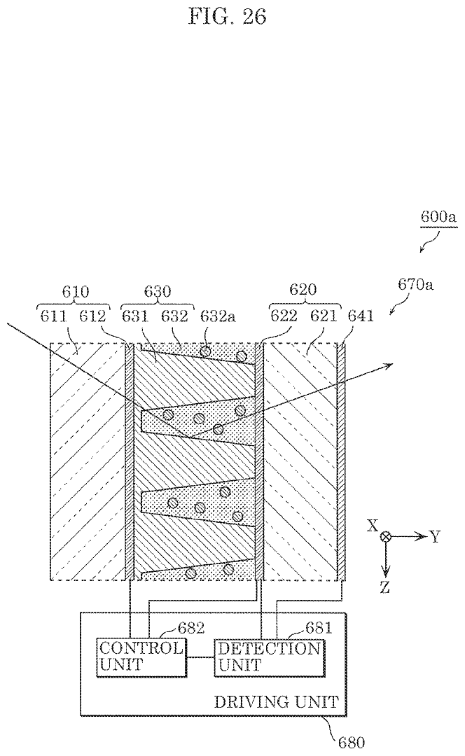

In Embodiment 3 above, second electrode 622 functions as a voltage application electrode for applying an electric field to liquid crystal portion 632, yet second electrode 622 may also be used not only as a voltage application electrode, but also as a detection electrode. Specifically, second electrode 622 may be used as both the voltage application electrode and the detection electrode. FIG. 26 illustrates a configuration of a daylighting system according to Variation 1 as described above.

As illustrated in FIG. 26, daylighting system 600a according to Variation 1 includes functional film 670a and driving unit 680. Functional film 670a includes third electrode 641 disposed on the second film substrate 620 side of functional film 670a. Third electrode 641 is formed on the other principal surface of second substrate 621. Second substrate 621 is located between second electrode 622 and third electrode 641. Functional film 670a does not include fourth electrode 642, intermediate layer 643, and adhesion layer 650.

In this case, detection unit 681 detects a user operation, using second electrode 622 and third electrode 641 as a pair of detection electrodes.

When a capacitive type is used as the detection type, detection unit 681 detects a change in the capacitance between second electrode 622 and third electrode 641 due to a user touching third electrode 641 (due to a user's hand approaching third electrode 641). When the self-capacitance type is adopted, for example, second electrode 622 is used as a ground electrode, and detection unit 681 detects an increase in the capacitance between second electrode 622 and third electrode 641, as a user operation. When the mutual capacitive type is adopted, second electrode 622 is used as a reception electrode, and third electrode 641 is used as a transmission electrode. Detection unit 681 detects, as a user operation, a decrease in capacitance between second electrode 622 and third electrode 641.

When the resistive type is adopted as the detection type, second substrate 621 includes an air space. Detection unit 681 uses second electrode 622 and third electrode 641 as a pair detection electrodes, and detects, as a user operation, contact of the pair of detection electrodes in the air space caused by a user pressing third electrode 641.

Thus, in daylighting system 600a, functional film 670a is thinner than functional film 670. Accordingly decrease in the light transmittance of functional film 670a is inhibited.

### [Variation 2 of Embodiment 3]

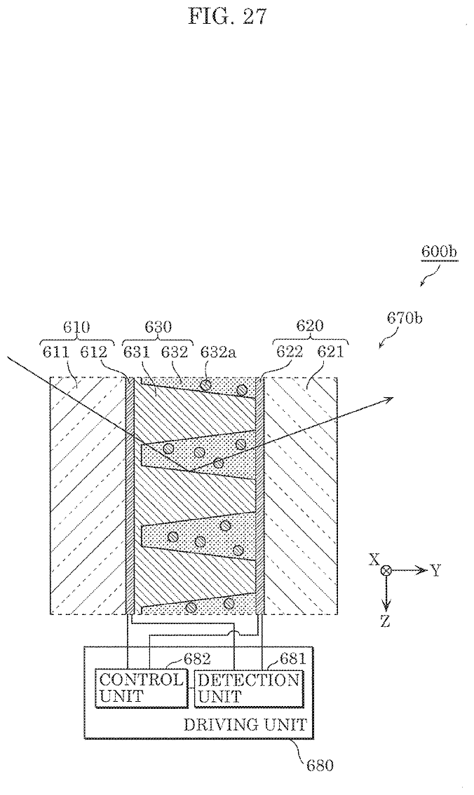

In Embodiment 3 above, first electrode 612 and second electrode 622 each function as a voltage application electrode for applying an electric field to liquid crystal portion 632, yet first electrode 612 and second electrode 622 may also be used not only as voltage application electrodes, but also as detection electrodes. Specifically first electrode 612 and second electrode 622 may be each used as both the voltage application electrode and the detection electrode, and functional film 670 may not include touch-panel layer 640. FIG. 27 illustrates a configuration of such a daylighting system according to Variation 2.

As illustrated in FIG. 27, daylighting system 600b according to Variation 2 includes functional film 670b and driving unit 680. Daylighting system 600b (functional film 670b) does not include touch-panel layer 640, but includes detection unit 681.

In this case, detection unit 681 detects a user operation, using first electrode 612 and second electrode 622 as a pair of detection electrodes. The capacitive type is used as the detection type.

For example, detection unit 681 uses an AC voltage applied by control unit 682 between first electrode 612 and second electrode 622 as a detection signal. Detection unit 681 can detect a change in capacitance, based on a change in the waveform (rounding of the waveform) of the AC voltage, due to a user touching second electrode 622 (due to a user's hand approaching second electrode 622). Note that in this case, a minute AC voltage may be applied also in the no-voltage applying state (the second mode) in order to detect operation by detection unit 681.

A detection signal may be superposed on the AC voltage applied by control unit 682 between first electrode 612 and second electrode 622. The frequency of the AC voltage applied by control unit 682 as mentioned above is about 100 Hz. Detection unit 681 superposes a detection signal having, for example, a frequency of about 1 kHz to 10 kHz (for example, a rectangular pulse) on such an AC voltage. Detection unit 681 can detect a change in capacitance, based on a change in the waveform (rounding of the waveform) of the detection signal, due to a user touching second electrode 622 (due to a user's hand approaching second electrode 622).

Such daylighting system 600b includes functional film 670b still thinner than functional film 670a. Accordingly, a decrease in the transmittance of functional film 670b is inhibited.

Note that the resistive type may be used as the detection type of detection unit 681. In this case, second electrode 622 is formed not on the one principal surface of second substrate 621 (the principal surface facing protruding and recessed structure 631), but on the other principal surface (a principal surface not facing protruding and recessed structure 631).

### Advantageous Effects of Embodiment 3 and Others

As described above, daylighting system 600 includes functional film 670 and driving unit 680. Functional film 670 includes: light-transmitting first film substrate 610 which includes first substrate 611, and first electrode 612 disposed on one principal surface of first substrate 611; light-transmitting second film substrate 620 which includes second substrate 621, and second electrode 622 disposed on one principal surface of second substrate 621; light distribution layer 630 which is disposed between first film substrate 610 and second film substrate 620, and includes recessed and protruding structure 631 which includes protrusions protruding toward second electrode 622, and liquid crystal portion 632 disposed in a space defined by the protrusions. Driving unit 680 includes detection unit 681 which detects a user operation on functional film 670, and control unit 682 which applies a voltage between first electrode 612 and second electrode 622, based on the user operation detected by detection unit 681.

Accordingly, daylighting system 600 includes detection unit 681 which detects a user operation on functional film 670, and thus when daylighting system 600 is installed in building 690, construction for installing an operation panel to building 690 can be omitted. Furthermore, when a plurality of functional films 670 are controlled using a single operation panel, buttons of the operation panel and the plurality of functional films 670 are associated with one another in the installation construction. Nevertheless, functional film 670 itself is the one to be operated, and thus such association is unnecessary. Thus, it can be said that daylighting system 600 is a system for which the scale of installation construction is reduced.

In daylighting system 600, functional film 670 further includes third electrode 641 and fourth electrode 642 which are disposed on the second film substrate 620 side of functional film 670, and stacked with intermediate layer 643 (an air layer or a dielectric layer) therebetween. Detection unit 681 may detect a user operation, using third electrode 641 and fourth electrode 642 as a pair of detection electrodes.

Accordingly, detection unit 681 can detect a user operation on functional film 670 itself, using touch-panel layer 640 disposed on the second film substrate 620 side.

In daylighting system 600a, functional film 670a further includes third electrode 641 disposed on second film substrate 620 of functional film 670a, and detection unit 681 detects a user operation, using second electrode 622 and third electrode 641 as a pair of detection electrodes.

Accordingly, second electrode 622 is used as both the voltage application electrode and the detection electrode, and thus thinner functional film 670a is achieved. Accordingly, a decrease in light transmittance of functional film 670a is inhibited.

In daylighting system 600b, detection unit 681 detects a user operation, using first electrode 612 and second electrode 622 as a pair of detection electrodes.

Accordingly, first electrode 612 and second electrode 622 are each used as both the voltage application electrode and the detection electrode, and thus thinner functional film 670b is achieved. Accordingly, a decrease in light transmittance of functional film 670b is inhibited.

Detection unit 681 may detect a change in capacitance between the pair of detection electrodes as a user operation.

Accordingly, detection unit 681 can detect a user operation on functional film 670, based on a change in capacitance between the pair of detection electrodes.

Detection unit 681 may detect, as a user operation, contact of the pair of detection electrodes.

Accordingly, detection unit 681 can detect a user operation on functional film 670, based on whether the pair of detection electrodes are brought into contact with each other.

Control unit 682 may apply an AC voltage between first electrode 612 and second electrode 622. Detection unit 681 may determine, as detection target period Ts for detecting a user operation, a period from first timing t1 at which first predetermined period has elapsed from the timing at which the polarity of the AC voltage has changed to second timing t2 prior, by second predetermined period T2, to a timing at which the polarity of the AC voltage changes next.

Accordingly a period when noise is readily generated, which includes a timing at which the polarity changes, is excluded from detection target period Ts. Accordingly this reduces the influence of noise on detection by detection unit 681, and inhibits incorrect detection.

### Embodiment 4

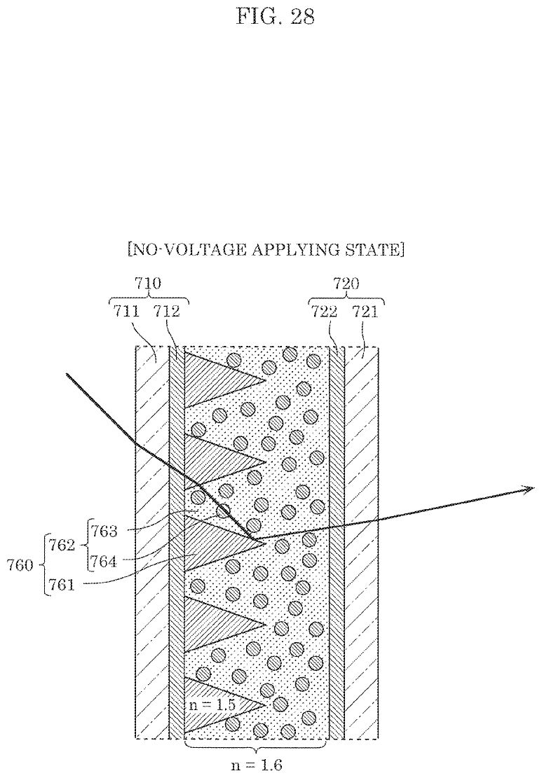

In Embodiments 1 to 3 described above, another refractive-index control portion (or in other words, a refractive-index control layer) may be used for the light distribution layer, instead of a liquid crystal portion (or in other words, a liquid crystal layer). The refractive-index control portion may exhibit different optical effects according to an applied electric field. For example, an electrophoretic portion (or in other words, an electrophoretic layer) may be used as the refractive-index control portion. FIGS. 28 to 30 are schematic cross sectional views illustrating the structures of the light distribution layer in which the electrophoretic portion is used as the refractive-index control portion, Note that when the electrophoretic portion is used as the refractive-index control portion, a DC voltage may be applied between two electrodes.

Light distribution layer 760 illustrated in FIGS. 28 to 30 is disposed between first film substrate 710 which includes first substrate 711 and first electrode 712 and second film substrate 720 which includes second substrate 721 and second electrode 722. First film substrate 710 and second film substrate 720 have a similar configuration to those of the first film substrate and the second film substrate described in Embodiments 1 to 3.

Light distribution layer 760 includes protruding and recessed structure 761 and electrophoretic portion 762. In electrophoretic portion 762, countless charged nano particles 764 are dispersed in insulating liquid 763.

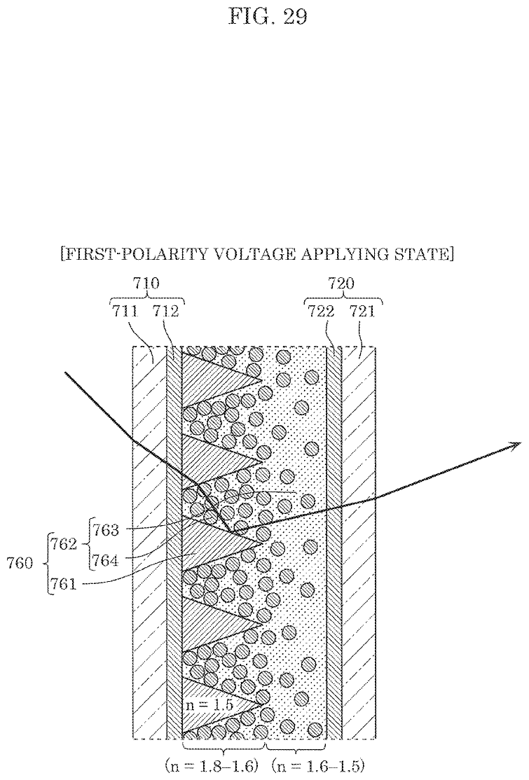

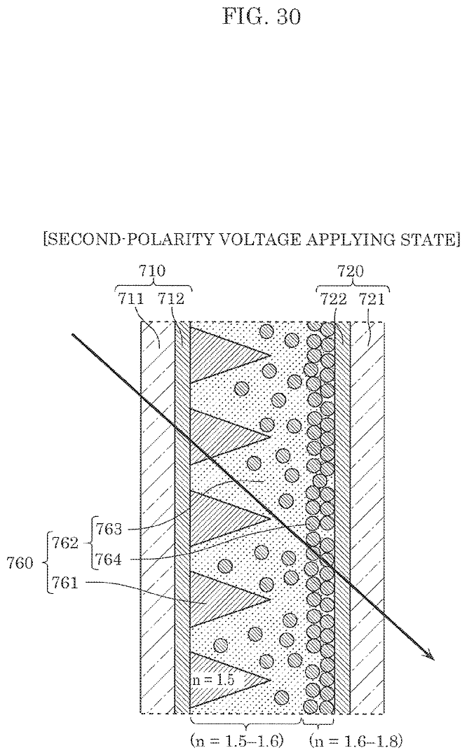

For example, a fluorocarbon hydrogen solution or a silicon oil having a refractive index (solvent refractive index) in a range from approximately 1.3 to approximately 1.5 is used as insulating liquid 763, and zirconia particles having a refractive index of 2.1 are used as nano particles 764. In electrophoretic portion 762, for example, the density of nano particles 764 in insulating liquid 763 may be adjusted such that an average refractive index of the entirety of electrophoretic portion 762 is 1.6 in the no-voltage applying state (FIG. 28: a state in which nano particles 764 are dispersed), and the refractive index of electrophoretic portion 762 at the interface with protruding and recessed structure 761 is 1.8 in the first polarity voltage applying state in which a voltage of a first polarity is applied (FIG. 29: a state in which nano particles 764 aggregate on the protruding and recessed structure 761 side). Note that in this case, the refractive index of electrophoretic portion 762 at the interface with protruding and recessed structure 761 may be 1.5 that is equal to the refractive index of protruding and recessed structure 761 in the second polarity voltage applying state in which a voltage of a second polarity opposite the first polarity is applied (FIG. 30: a state in which nano particles 764 aggregate on the second electrode 722 side which faces protruding and recessed structure 761).

Thus, light distribution layer 760 in which electrophoretic portion 762 is used can increase a difference in refractive index between protruding and recessed structure 761 and electrophoretic portion 762, as compared with the light distribution layer in which the liquid crystal portion is used. Accordingly a light distribution control range can be increased. Light distribution layer 760 in which electrophoretic portion 762 is used can distribute a greater portion of incident light than the light distribution layer in which the liquid crystal portion is used can distribute. The light distribution layer in which the liquid crystal portion is used can distribute either S waves or P waves included in incident light, yet light distribution layer 760 in which electrophoretic portion 762 is used can distribute both S waves and P waves included in incident light.

### Others

The above has described the daylighting system according to the present invention, based on the embodiments and the variations thereof yet the present invention is not limited to the embodiments.

For example, Embodiment 1 above has described an example in which the color sensor detects an illuminance and a color temperature, yet the present invention is not limited thereto. For example, the weather detection unit may include an illuminance sensor and a color temperature sensor, instead of the color sensor.

For example, in the above embodiments, the functional film is disposed on a window in such a manner that the longitudinal direction of the protrusions is horizontal, yet the present invention is not limited thereto. For example, the functional film may be disposed on a window in such a manner that the longitudinal direction of the protrusions is perpendicular (vertical).

Furthermore, for example, in the above embodiments, the protrusions included in the protruding and recessed structure each have an elongated shape, yet the present invention is not limited thereto. For example, the protrusions may be scattered in a matrix manner, for instance. Specifically the protrusions may be scattered in a dotted manner,

For example, in the above embodiments, the protrusions have the same shape, yet the present invention is not limited thereto, and may have different shapes within a plane, for example. For example, the angles of tilt of the lateral surfaces of the protrusions may be different for the upper half and the lower half of the functional film in a perpendicular direction.

For example, in the above embodiments, the protrusions have a fixed height, yet the present invention is not limited thereto. For example, the protrusions may have randomly different heights. In this manner, light which passes through the functional film can be inhibited from appearing in rainbow colors. Specifically, since the protrusions have randomly different heights, the wavelengths of minute diffracted light and minute diffuse light at the protruding and recessed interface are equalized, so that exiting light is inhibited from being colored.

For example, in the above embodiments, as the material of the liquid crystal portion of the light distribution layer, a material that includes polymers such as a polymer structure other than the liquid crystal material may be used. The polymer structure is a reticular structure, for example, and liquid crystal molecules are disposed in the polymer structure (the interstices of the reticulation), whereby a refractive index carp be controlled. As a liquid crystal material which includes polymers include, for example, polymer dispersed liquid crystal (PDLC) or polymer network liquid crystal (PNLC) can be used.

In the above embodiments, the functional film is applied onto a surface of a window on the indoor side, but may be applied onto a surface of a window on the outdoor side. When the functional film is applied onto a surface of a window on the indoor side, the functional film can be inhibited from deteriorating. Although the functional film is applied onto a window, the functional film may be used as the window of a building itself. Where the functional film is installed is not limited to a window of a building, and the functional film may be installed on a window of a car, for example.

In Embodiment 3 above, the touch-panel layer (the third electrode) is disposed on the indoor side of the functional film, but may be disposed on the outdoor side. Specifically, in Embodiment 3, the protruding and recessed structure may protrude from the second electrode side toward the first electrode. Accordingly, the user can perform operation from the outdoor side.

In Embodiment 3 above, the detection unit detects a touch operation of a user on the functional film, but may detect a non-contact operation of the user onto the functional film. For example, when the capacitive type is adopted, capacitance may change even due to approach of a user to the functional film, and thus the detection unit can also detect a non-contact operation which is made by a user not touching the functional film.

The present invention may also include embodiments as a result of adding, to the embodiments, various modifications that may be conceived by those skilled in the art, and embodiments obtained by combining elements and functions in the embodiments in any manner without departing from the spirit of the present invention.

### REFERENCE MARKS IN THE DRAWINGS

10, 10a, 10b, 10c, 600, 600a, 600b daylighting system

20 outdoor area

21 indoor area

90, 92 direct light

91 diffuse light

100, 670, 670a, 670b functional film

110, 611, 711 first substrate

120, 621, 721 second substrate

130, 630, 760 light distribution layer

131, 631, 761 protruding and recessed structure

132, 632 liquid crystal portion

133 protrusion

135, 632a liquid crystal molecule

140, 612, 712 first electrode

150, 622, 722 second electrode

200, 500, 501, 502 weather detection unit

300, 682 control unit

510 pyrheliometer

511 diffuse light meter

512 pyranometer

513 first illuminance sensor

514 second illuminance sensor

641 third electrode

642 fourth electrode

681 detection unit

1. A daylighting system, comprising:
a functional film which transmits light from an outdoor area to introduce the light to an indoor area;
a weather detection unit configured to detect weather in a location at which the functional film is installed; and
a control unit configured to control a transmittance of the functional film, based on a result of detection by the weather detection unit, wherein
the weather detection unit is configured to detect the weather, based on a result of comparing an illuminance of the light from the outdoor area with a reference value for the illuminance, and a result of comparing a color temperature of the light from the outdoor area with a reference value for the color temperature.

2. The daylighting system according to claim 1, wherein
the weather detection unit is configured to determine that the weather is cloudy when the illuminance is lower than a first reference value and the color temperature is higher than a second reference value, and
the control unit is configured to increase the transmittance of the functional film when the weather detection unit determines that the weather is cloudy.

3. A daylighting system, comprising:
a functional film which transmits light from an outdoor area to introduce the light to an indoor area;
a weather detection unit configured to detect weather in a location at which the functional film is installed; and
a control unit configured to control a transmittance of the functional film, based on a result of detection by the weather detection unit, wherein
the weather detection unit is configured to detect the weather, based on a result of comparing a reference value with a ratio of direct light and diffuse light which are included in the light from the outdoor area.

4. The daylighting system according to claim 3, wherein
the weather detection unit is configured to determine that the weather is cloudy when a ratio of diffuse irradiance to direct irradiance is greater than a third reference value, and
the control unit is configured to increase the transmittance of the functional film when the weather detection unit determines that the weather is cloudy.

5. The daylighting system according to claim 4, wherein
the weather detection unit includes:
a pyrheliometer which detects the direct irradiance; and
a diffuse light meter which detects the diffuse irradiance, and
the weather detection unit is configured to calculate the ratio of the diffuse irradiance to the direct irradiance.

6. The daylighting system according to claim 4, wherein
the weather detection unit includes:
a pyrheliometer which detects the direct irradiance; and
a pyranometer which detects global irradiance, and
the weather detection unit is configured to calculate the diffuse irradiance by subtracting the direct irradiance from the global irradiance, to calculate the ratio of the diffuse irradiance to the direct irradiance.

7. The daylighting system according to claim 4, wherein
the weather detection unit includes:
a first illuminance sensor which detects a first illuminance of the light from the outdoor area; and
a second illuminance sensor which is disposed tilted by a predetermined angle relative to the first illuminance sensor, and detects a second illuminance of the light from the outdoor area, and
the weather detection unit is configured to calculate the ratio of the diffuse irradiance to the direct irradiance, based on the first illuminance and the second illuminance.

8. The daylighting system according to claim 7, wherein
the predetermined angle is 90 degrees.

9. The daylighting system according to claim 1, wherein
the functional film has a light distribution mode in which light which has entered is bent and caused to travel in a predetermined direction, and a transparent mode in which a transmittance is higher than a transmittance in the light distribution mode, and the light which has entered is caused to travel straight, and
the control unit is configured to:
cause the functional film to operate in the light distribution mode when the weather detected by the weather detection unit is sunny; and
cause the functional film to operate in the transparent mode when the weather detected by the weather detection unit is cloudy.

10. The daylighting system according to claim 9, wherein
the functional film includes:
a first substrate and a second substrate which are light-transmitting substrates facing each other;
a light distribution layer which is disposed between the first substrate and the second substrate, and distributes the light which has entered; and
a first electrode and a second electrode which are disposed with the light distribution layer therebetween,
the light distribution layer includes:
a protruding and recessed structure which includes a plurality of protrusions; and
a refractive-index control portion in a space defined by the plurality of protrusions, and
the control unit is configured to control an operational mode of the functional film by controlling, based on a result of detection by the weather detection unit, a voltage applied between the first electrode and the second electrode.

11. The daylighting system according to claim 10, wherein
the control unit is configured to switch between an automatic mode for controlling the transmittance of the functional film based on the result of detection by the weather detection unit and a manual mode for controlling the transmittance of the functional film according to a user operation.

12. The daylighting system according to claim 11, further comprising:
a detection unit configured to detect the user operation on the functional film, wherein
the control unit is configured to switch between the automatic mode and the manual mode, based on the user operation detected by the detection unit.

13. The daylighting system according to claim 12, wherein
in the manual mode, the control unit is configured to control the transmittance of the functional film, based on the user operation detected by the detection unit.

14. The daylighting system according to claim 12, wherein
the functional film further includes a third electrode and a fourth electrode which are stacked with an air layer or a dielectric layer therebetween,
the second substrate is located between the second electrode and the third electrode, and
the detection unit is configured to use the third electrode and the fourth electrode as a pair of detection electrodes to detect the user operation.

15. The daylighting system according to claim 12, wherein
the functional film further includes a third electrode,
the second substrate is located between the second electrode and the third electrode, and
the detection unit is configured to use the second electrode and the third electrode as a pair of detection electrodes to detect the user operation.

16. The daylighting system according to claim 12, wherein
the detection unit is configured to use the first electrode and the second electrode as a pair of detection electrodes to detect the user operation.

17. The daylighting system according to claim 1, wherein
the weather detection unit is configured to repeat weather detection, and
when the weather detection unit has consecutively obtained results of the weather detection that indicate identical weather over a predetermined period, the weather detection unit is configured to determine that the weather is the identical weather indicated by the results consecutively obtained by the weather detection unit.

18. The daylighting system according to claim 17, wherein
the weather detection unit is configured to:
determine that the weather is cloudy when the weather detection unit has consecutively obtained results of the weather detection that indicate cloudy weather over a first period; and
determine that the weather is sunny when the weather detection unit has consecutively obtained results of the weather detection that indicate sunny weather over a second period, and
the first period is longer than the second period.

19. The daylighting system according to claim 1, wherein
the weather detection unit is configured to further calculate the reference value for the illuminance and the reference value for the color temperature, based on geographic information and date and time information of the location.
